(19) United States
(12) Patent Application Publication
(10) Pub. No.: US 2026/0040173 A1
(43) Pub. Date: Feb. 5, 2026

(54) METHOD AND APPARATUS FOR OBTAINING INTERNET PROTOCOL ADDRESS OF A BASE STATION IN A WIRELESS COMMUNICATION SYSTEM

(71) Applicant: Samsung Electronics Co., Ltd., Gyeonggi-do (KR)

(72) Inventors: Fanhua KONG, Beijing (CN); Weiwei WANG, Beijing (CN)

(21) Appl. No.: 19/287,277

(22) Filed: Jul. 31, 2025

(30) Foreign Application Priority Data
Aug. 5, 2024 (CN) 202411068234.X

(51) Int. Cl. H04W 36/12; H04L 5/00; H04W 36/00; H04W 76/20

(52) U.S. Cl. CPC H04W 36/12; H04L 5/0053; H04W 36/0016; H04W 76/20

(57) ABSTRACT

The disclosure relates to a 5G or 6G communication system for supporting a higher data transmission rate. A method performed by a first node in a wireless communication system includes receiving first information and fourth information from a WAB-MT, wherein the first information comprises at least one of information indicating that the WAB-MT is a WAB node or a WAB-MT, an identification of a co-located WAB-gNB of the WAB-MT, a request for an IP address of the first node, and the fourth information comprises a request for an IP address of a neighbor node of the first node, and transmitting second information and fifth information to the WAB-MT, wherein the second information comprises the IP address of the first node, and the fifth information comprises the IP address of the neighbor node of the first node, wherein the IP address is used for the co-located WAB-gNB of the WAB-MT to transmit an Xn setup request to the first node, and wherein the IP address of the neighbor node is used for the co-located WAB-gNB of the WAB-MT to transmit an Xn setup request to the neighbor node.

### CROSS REFERENCE TO RELATED APPLICATION(S)

This application is based on and claims priority under 35 U.S.C. § 119(a) to Chinese patent application number 202411068234.X, which was filed in the Chinese Patent Office on Aug. 5, 2024, the entire disclosure of which is incorporated herein by reference.

### BACKGROUND

### 1. Field

The disclosure relates generally to wireless communication technologies, and more particularly, to a method and apparatus for obtaining an Internet protocol (IP) address of a base station (BS) in a wireless communication system.

### 2. Description of Related Art

5^{th} generation (5G) mobile communication technologies define broad frequency bands such that high transmission rates and new services are possible and can be implemented not only in sub 6 gigahertz (GHz) bands such as 3.5 GHz, but also in above 6 GHz bands referred to as millimeter wave (mmWave) including 28 GHz and 39 GHz bands. In addition, it has been considered to implement 6^{th} generation (6G) mobile communication technologies referred to as beyond 5G systems in terahertz (THz) bands (for example, 95 GHz to 3 THz bands) to realize transmission rates fifty times faster than 5G mobile communication technologies and ultra-low latencies one-tenth of 5G mobile communication technologies.

Since the beginning of the development of 5G mobile communication technologies, to support services and to satisfy performance requirements in connection with enhanced mobile broadband (eMBB), ultra reliable low latency communications (URLLC), and massive machine-type communications (mMTC), there has been ongoing standardization regarding beamforming and massive multiple input multiple output (MIMO) for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of a bandwidth part (BWP), new channel coding methods such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying two-step random access channel (2-step RACH) procedures for NR. There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Such development of 5G mobile communication systems will serve as a basis for developing not only new waveforms for providing coverage in terahertz bands of 6G mobile communication technologies, multi-antenna transmission technologies such as full dimensional MIMO (FD-MIMO), array antennas and large-scale antennas, metamaterial-based lenses and antennas for improving coverage of THz band signals, high-dimensional space multiplexing technology using orbital angular momentum, and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

Wireless communication is one of the most successful innovations in modern history. Recently, the number of subscribers of wireless communication services has exceeded 5 billion, and it continues to rapidly increase. With the increasing popularity of smart phones and other mobile data devices (such as tablet computers, notebook computers, netbooks, e-book readers and machine-type devices) in consumers and enterprises, and to meet rapid growth of mobile data services and support new applications and deployments, there is a need in the art for improved efficiency and coverage of wireless interfaces.

In 5G communication technology, faster transmission speeds than 4^{th} generation (4G) are achieved because higher frequencies are used. However, higher frequencies lead to shorter transmission distances, so more BSs will be deployed in a 5G network to ensure coverage of the 5G network. However, normal deployment of 5G BSs in some areas is not feasible due to environmental or cost reasons. Therefore, to alleviate the matter of 5G BSs being unable to cover these areas, there is a need in the art for the use of wireless access backhaul (WAB) technology to ensure normal communication of users.

### SUMMARY

The disclosure has been made to address at least the above-mentioned problems and/or disadvantages and to provide at least the advantages described below.

In accordance with an aspect of the disclosure, a method performed by a first node in a wireless communication system includes receiving first information and fourth information from a WAB-mobile terminal (WAB-MT), wherein the first information comprises at least one of information indicating that the WAB-MT is a WAB node or a WAB-MT, an identification of a co-located WAB-gNB of the WAB-MT, a request for an IP address of the first node, and the fourth information comprises a request for an IP address of a neighbor node of the first node, and transmitting second information and fifth information to the WAB-MT, wherein the second information comprises the IP address of the first node, and the fifth information comprises the IP address of the neighbor node of the first node, wherein the IP address is used for the co-located WAB-gNB of the WAB-MT to transmit an Xn setup request to the first node, and wherein the IP address of the neighbor node is used for the co-located WAB-gNB of the WAB-MT to transmit an Xn setup request to the neighbor node.

In accordance with another aspect of the disclosure, a method performed by a WAB-MT in a wireless communication system includes transmitting first information and fourth information to a first node, wherein the first information comprises at least one of information indicating that the WAB-MT is a WAB node or a WAB-MT, an identification of a co-located WAB-gNB of the WAB-MT, a request for an IP address of the first node, and the fourth information comprises a request for an IP address of a neighbor node of the first node; and receiving second information and fifth information from the first node, wherein the second information comprises the IP address of the first node, and the fifth information comprises the IP address of the neighbor node of the first node, wherein the IP address is used for the co-located WAB-gNB of the WAB-MT to transmit an Xn setup request to the first node, and wherein the IP address of the neighbor node is used for the co-located WAB-gNB of the WAB-MT to transmit an Xn setup request to the neighbor node.

In accordance with another aspect of the disclosure, a method includes receiving a radio resource control (RRC) reconfiguration message from a WAB-gNB; and transmitting an RRC reconfiguration complete message to a first node, wherein first and fourth information are transmitted from a co-located WAB-MT of the WAB-gNB to the first node, wherein the first information comprises at least one of information indicating that the WAB-MT is a WAB node or a WAB-MT, an identification of the WAB-gNB, a request for an IP address of the first node, and the fourth information comprises a request for an IP address of a neighbor node of the first node, wherein second information and fifth information are transmitted from the first node to the WAB-MT, wherein the second information comprises the IP address of the first node and the fifth information comprises the IP address of the neighbor node of the first node, wherein the IP address is used for the WAB-gNB to transmit an Xn setup request to the first node, and wherein the IP address of the neighbor node is used for the co-located WAB-gNB to transmit an Xn setup request to the neighbor node.

In accordance with another aspect of the disclosure, a node device in a wireless communication system includes a transceiver configured to transmit and receive signals; and a controller coupled to the transceiver and configured to perform any method performed by any node device such as a first node in a wireless communication system according to an embodiment.

In accordance with another aspect of the disclosure, a WAB-MT in a wireless communication system includes a transceiver configured to transmit and receive signals; and a controller coupled to the transceiver and configured to perform any method performed by a WAB-MT in a wireless communication system according to an embodiment.

In accordance with another aspect of the disclosure, a UE in a wireless communication system includes a transceiver configured to transmit and receive signals; and a controller coupled to the transceiver and configured to perform any method performed by a UE in a wireless communication system according to an embodiment.

In accordance with another aspect of the disclosure, a WAB-gNB in a wireless communication system includes a transceiver configured to transmit and receive signals; and a controller coupled to the transceiver and configured to perform any method performed by a WAB-gNB in a wireless communication system according to an embodiment.

### BRIEF DESCRIPTION OF DRAWINGS

The above and other aspects, features and advantages of certain embodiments of the present disclosure will be more apparent from the following description taken in conjunction with the accompanying drawings, in which:

FIG. 1 illustrates a system architecture of system architecture evolution (SAE) according to an embodiment;

FIG. 2 illustrates a system architecture according to an embodiment;

FIG. 3A illustrates a BS according to an embodiment;

FIG. 3B illustrates a BS according to an embodiment;

FIG. 3C illustrates a BS according to an embodiment;

FIG. 4 illustrates a WAB node in a wireless communication system according to an embodiment;

FIG. 5 illustrates when a normal gNB discovers a neighbor cell and establishes an Xn interface with the neighbor cell according to an embodiment;

FIG. 6 illustrates when a WAB discovers neighbor gNBs during mobility according to an embodiment;

FIG. 7 illustrates a message delivery for a WAB-gNB to obtain the IP address of gNB1 under the BH AMF according to an embodiment;

FIG. 8A illustrates a first embodiment according to an embodiment;

FIG. 8B illustrates an example UE handover process according to an embodiment;

FIG. 9 illustrates a second embodiment according to an embodiment;

FIG. 10 illustrates a third embodiment according to an embodiment;

FIG. 11 illustrates a fourth embodiment according to an embodiment;

FIG. 12 illustrates a fifth embodiment according to an embodiment;

FIG. 13 illustrates an example scenario of network connection according to an embodiment;

FIG. 14 illustrates an example scenario 1 in which a WAB-gNB hands over a UE to a BH gNB according to an embodiment;

FIG. 15 illustrates an example scenario 2 in which a WAB-gNB hands over a UE to a neighbor gNB according to an embodiment;

FIG. 16 illustrates a method performed by a first node in a wireless communication system according to an embodiment;

FIG. 17 illustrates a method performed by a WAB-MT in a wireless communication system according to an embodiment;

FIG. 18 illustrates a method performed by a UE in a wireless communication system according to an embodiment;

FIG. 19 illustrates a node in a wireless communication system according to an embodiment;

FIG. 20 illustrates a WAB-MT in a wireless communication system according to an embodiment;

FIG. 21 illustrates a WAB-gNB in a wireless communication system according to an embodiment;

FIG. 22 illustrates a UE in a wireless communication system according to an embodiment;

FIG. 23 is a terminal or UE according to an embodiment;

FIG. 24 is a BS according to an embodiment; and

FIG. 25 is a network entity according to an embodiment.

### DETAILED DESCRIPTION

Hereinafter, embodiments of the disclosure are described in detail with reference to the accompanying drawings. It should be noted that in the drawings, the same or similar elements are preferably denoted by the same or similar reference numerals. Detailed descriptions of known functions or configurations that may cause the subject matter of the disclosure unclear will be omitted for the sake of clarity and conciseness.

Terms described below are terms defined in consideration of functions in the disclosure, which may vary according to intentions or customs of users and providers. Therefore, the definition should be made based on the content throughout this specification.

Some components are exaggerated, omitted, or schematically illustrated in the accompanying drawings. The size of each component does not fully reflect the actual size. In each drawing, the same reference numerals are given to the same or corresponding components.

Embodiments of the disclosure enable a constitution of the disclosure to be complete, and are provided to fully inform the scope of the disclosure to those of ordinary skill in the art to which the disclosure pertains.

Like reference numerals refer to like components throughout the specification.

Herein, a unit may refer to a software element or a hardware element, such as a field programmable gate array (FPGA) or an application specific integrated circuit (ASIC), which performs a predetermined function. However, the term including the word unit does not always have a meaning limited to software or hardware. The unit may be constructed either to be stored in an addressable storage medium or to execute one or more processors. Therefore, the unit includes software elements, object-oriented software elements, components such as class elements and task elements, processes, functions, properties, procedures, sub-routines, segments of a program code, drivers, firmware, micro-codes, circuits, data, database, data structures, tables, arrays, and parameters. The components and functions provided by the unit may be either combined into fewer components and a unit, or divided into additional components and a unit. Moreover, the components and units may be implemented to reproduce one or more central processing units (CPUs) within a device or a security multimedia card. The ^{˜}unit may include one or more processors.

Herein, the transmission of data refers to the reception and/or transmission of data.

IP address and TNL address may be used interchangeably.

A cell/node list may refer to a list of IDs and/or other identification information of cells/nodes.

Since WAB-MT can support at least part of UE functions, in some application scenarios, WAB-MT may be considered as a UE or a terminal device. However, since the WAB-MT is included in a WAB node, in some application scenarios, the WAB-MT may also be considered as a node device or a part of a node device. Whether a WAB-MT is defined as a UE or a node device mainly depends on the application scenario and is not limited herein.

Adding specific information to a message for transmitting is only an example. It should be understood that any information such as the first information, the second information, the third information, etc. may be transmitted alone or in combination, or may be transmitted through any existing or future message and/or signaling, etc., which is not limited herein.

The term “carrying” may also be used interchangeably with “including.”

A WAB node consists of a WAB-gNB and a WAB-MT. A WAB-gNB constituting a WAB node together with a WAB-MT may be referred to as a co-located WAB-gNB of the WAB-MT. Similarly, a WAB-MT constituting a WAB node together with a WAB-gNB may be referred to as a co-located WAB-MT of the WAB-gNB.

Hereinafter, the determination of priority between A and B may refer to various actions such as selecting the one having a higher priority based on a predefined priority rule and performing an operation corresponding thereto, or omitting or dropping an operation corresponding to the one having a lower priority.
“A or B” may be understood as “A and/or B,” which may include A, or B, or both A and B.
“at least one of A, B, and C” may be understood to include A, or B, or C, or any combination of A, B, and C.
“at least one of A, B, or C” may be understood to include A, or B, or C, or any combination of A, B, and C.
“A/B” may be understood as “A and/or B,” which may include A, or B, or both A and B.
“A, B” may be understood as “A and/or B,” which may include A, or B, or both A and B.
“A and B” may be understood as “A and/or B,” which may include A, or B, or both A and B.
“if condition A and condition B are satisfied,” may not be limited to when both condition A and condition B are satisfied, but may be understood to include when either condition A or condition B is individually satisfied, both condition A and condition B are satisfied, or one or more additional conditions are satisfied in combination.

Throughout this disclosure, ordinal terms such as “first,” “second,” “third,” etc., (and similar qualifiers) are used merely to distinguish between different instances, occurrences, configurations, messages, stages, or aspects of elements, operations, or information as described herein. Unless the context clearly dictates otherwise, the use of such ordinal terms does not itself require that the elements, operations, or information distinguished by these terms be structurally different, numerically distinct, or substantively dissimilar. For example, a “first signal” and a “second signal” may refer to instances of the same signal transmitted at different times or containing the same core information despite minor variations, or they may refer to signals with different content or characteristics, depending on the specific context. Similarly, a “first value” and a “second value” may represent the same magnitude but measured or applied in different circumstances, or they may represent different magnitudes. The interpretation should be guided by the specific technical context, function, and relationship described herein.

The terms “first ˜”, “second ˜”, etc., herein with respect to various elements (e.g., information, objects, operation, sequences, or the like), should not limit those elements. These terms may only be intended to distinguish one element from another and may not be intended to indicate a specific order. For example, a first element could be termed a second element, and, similarly, a second element could be termed a first element.

Even if “first ˜” and “second ˜” are described herein, it may be understood that element(s) referred to by “first ˜” and “second ˜” may be the same or different. For example, in case of element(s) being information, first information and second information may both be same information and, in some cases, are separate and different information.

The terms “if ˜” and “in case that ˜” as used in the disclosure may be interpreted to include the meanings of “when (or upon) ˜,” “in response to ˜,” “based on ˜,” or “according to ˜,” and may be used interchangeably with these expressions. In addition, expressions other than those exemplified herein may also be used when they have substantially the same meaning and do not impair the technical features of the present disclosure.

For example, the physical layer signaling may be referred to as layer 1 (L1) signaling and may include downlink control information (DCI). The higher layer signaling may include a medium access control (MAC) control message, a RRC signaling message, a non-access stratum (NAS) signaling message, or an application layer message. The RRC signaling message may be referred to as layer 3 (L3) signaling. It should be noted, however, that the higher layer signaling is not limited to the aforementioned examples.

The term “not perform” as used herein may, in context, be understood to indicate that the corresponding step is omitted or skipped. Such a term may be replaced with other terms having the same or substantially equivalent meaning.

In addition, “transmitting a message including A and B” as described herein, may be understood as encompassing both (i) transmitting A and B in a single message, and (ii) transmitting A and B separately via multiple messages (e.g., transmitting a first message including A and a second message including B). This interpretation may also apply to messages that include two or more items (e.g., A, B, C), transmitted either together or separately.

In addition, “transmitting a message including A and transmitting a message including B” may also be interpreted as transmitting a message including A and B in a single message.

The terms used in the following description to refer to access nodes, network entities, messages, interfaces between network entities, various types of identification information, and the like, are provided merely for the convenience of explanation by way of example. Therefore, the present disclosure is not limited to the terms described below, and other terms having equivalent technical meanings may also be used. Such terms may also be interchangeable with terms defined in any 3GPP TS where appropriate.

Hereinafter, a BS is an entity that allocates resources to terminals, and may be at least one of a gNode B, an eNode B, a Node B, a wireless access unit, a BS controller, or a node on a network.

The BS herein may include a split architecture comprising a central unit (CU) and a distributed unit (DU). In this structure, the CU is configured to process the higher layers of the control and user planes, while the DU is configured to process lower-layer radio resource functions. The embodiments herein may be equally applicable to 5G BS architectures in which such CU and DU functional splits are implemented.

A terminal may include a UE, a mobile station (MS), a cellular phone, a smartphone, a computer, or a multimedia system capable of performing communication functions.

Herein, a downlink (DL) refers to a radio link through which a BS transmits a signal to a UE, and an uplink (UL) refers to a radio link through which a UE transmits a signal to a BS.

5G mobile communication technologies may be described by way of example, but the embodiments may also be applied to other communication systems having similar technical backgrounds or channel types. For example, newly evolved mobile communication systems developed after 5G and 6G may be included. Furthermore, based on determinations by those skilled in the art, the embodiments of the present disclosure may also be applied to other communication systems (e.g., Wi-Fi systems) through some modifications without significantly departing from the scope of the present disclosure

In the following description, the terms physical channel and signal may be used interchangeably with data or control signal. For example, the term physical downlink shared channel (PDSCH) refers to a physical channel through which data is transmitted, but the term PDSCH may also be used to refer to the data itself. That is, the expression “transmit a physical channel” may be interpreted as being equivalent to the expression “transmit data or a signal via a physical channel.”

Hereinafter, in the context of the present disclosure, higher layer signaling may correspond to at least one of master information block (MIB), system information block (SIB) or SIB M (M=1, 2, . . . ), RRC, or MAC control element (CE), or a NAS signaling message, or an application layer message. The RRC signaling message may be referred to as L3 signaling.

In addition, L1 signaling may correspond to at least one of physical downlink control channel (PDCCH), DCI, UE-specific DCI, group-common DCI, common DCI, scheduling DCI (e.g., DCI used for scheduling downlink or uplink data), non-scheduling DCI (e.g., DCI not used for scheduling downlink or uplink data) physical uplink control channel (PUCCH), or uplink control information (UCI). The L1 signaling message may be referred to as a physical layer signaling.

Hereinafter, the expression indicating that information is configured by the BS, as used herein or claims, may, in context, be understood to indicate that the terminal receives the corresponding information from the BS via a physical layer signaling or a higher layer signaling. Such an expression may be replaced with other terms having the same or substantially equivalent meaning.

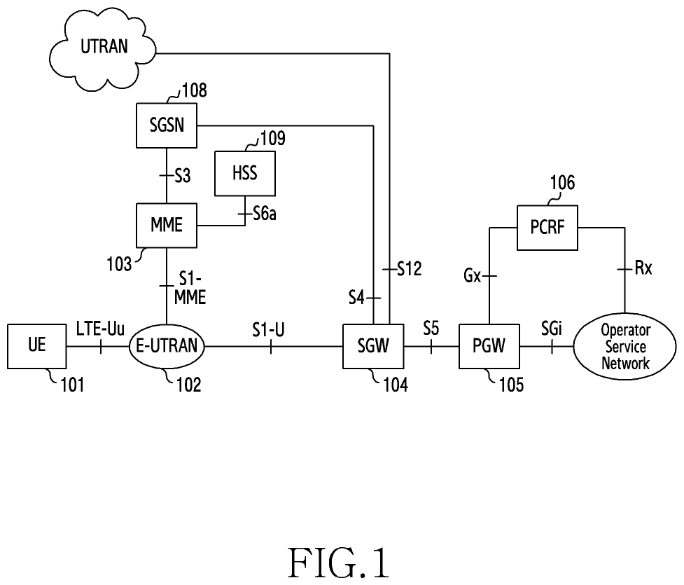

FIG. 1 illustrates a system architecture 100 of system architecture evolution (SAE) according to an embodiment. Referring to FIG. 1, a UE 101 is a terminal device for receiving data. An evolved universal terrestrial radio access network (E-UTRAN) 102 is a radio access network, which includes a macro BS (eNodeB/NodeB) that provides UE with interfaces to access the radio network. A mobility management entity (MME) 103 is responsible for managing mobility context, session context and security information of the UE. A serving gateway (SGW) 104 mainly provides functions of user plane, and the MME 103 and the SGW 104 may be in the same physical entity. A packet data network gateway (PGW) 105 is responsible for charging, lawful interception, etc., and may be in the same physical entity as the SGW 104. A policy and charging rules function entity (PCRF) 106 provides quality of service (QoS) policies and charging criteria. A general packet radio service support node (SGSN) 108 is a network node device that provides routing for data transmission in a universal mobile telecommunications system (UMTS). A home subscriber server (HSS) 109 is a home subsystem of the UE, and is responsible for protecting user information including a current location of the UE, an address of a serving node, user security information, and packet data context of the UE, etc.

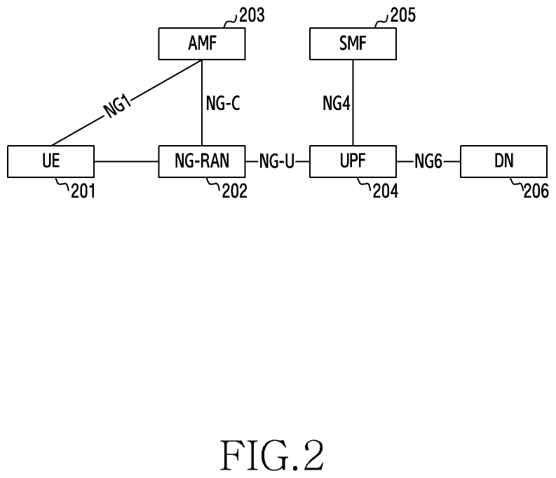

FIG. 2 illustrates a system architecture 200 according to an embodiment.

Referring to FIG. 2, a UE 201 is a terminal device for receiving data. A next generation radio access network (NG-RAN) 202 is a radio access network, which includes a BS (a gNB or an eNB connected to 5G core network 5GC, and the eNB connected to the 5GC is also called ng-eNB) that provides UE with interfaces to access the radio network. An access and mobility management function (AMF) entity 203 is responsible for managing mobility context and security information of the UE. A user plane function (UPF) entity 204 provides user plane functions. A session management function SMF entity 205 is responsible for session management. A data network (DN) 206 includes services of operators, access of Internet and service of third parties.

In an NR system, to support network function virtualization and more efficient resource management and scheduling, a BS (gNB/ng-eNB) that provides wireless network interfaces for UEs may be further divided into a centralized unit (for example, gNB-CU/ng-eNB-CU (gNB CU/ng-eNB CU)) and a DU (for example, gNB-DU/ng-eNB-DU (gNB DU/ng-eNB DU)) (abbreviated as CU and DU herein),

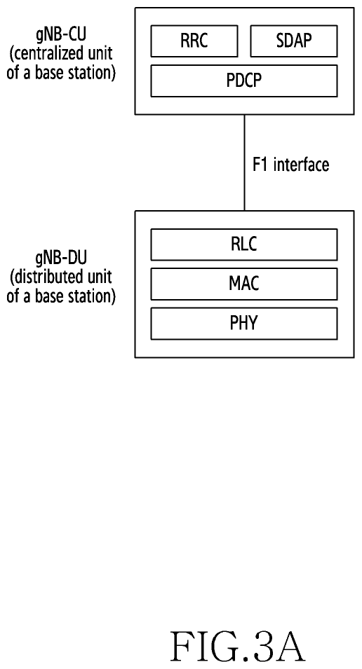

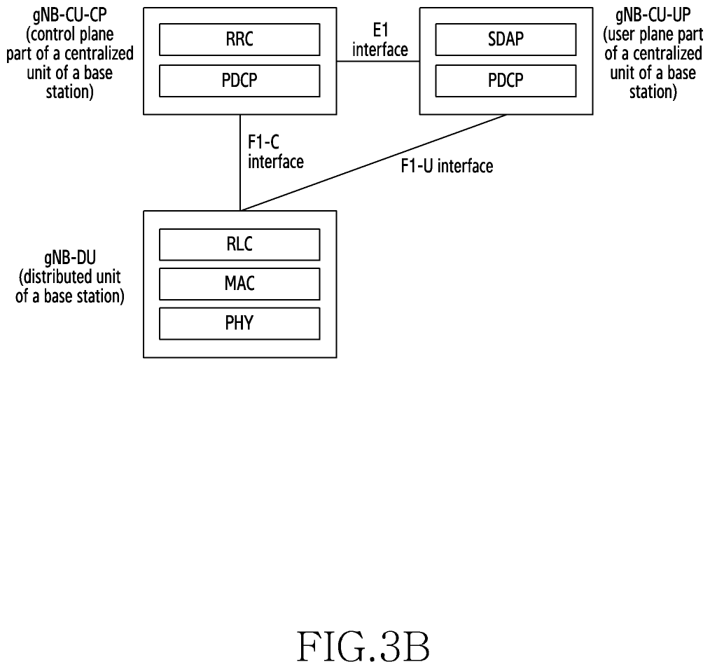

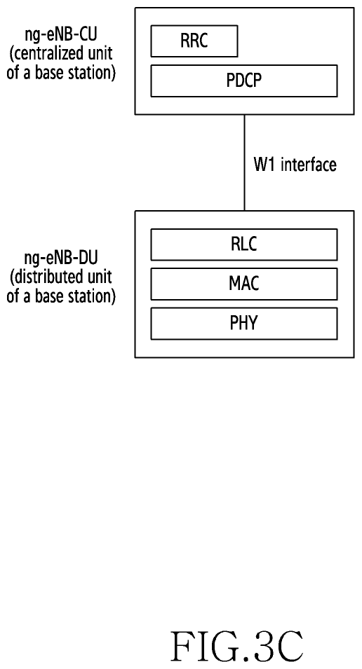

FIG. 3A illustrates a BS according to an embodiment. Referring to FIG. 3A. gNB-CU has RRC, service data adaptation protocol (SDAP) and packet data convergence protocol (PDCP) layers, while ng-eNB-CU has RRC and PDCP layers. gNB-DU/ng-eNB-DU has radio link control (RLC) protocol, MAC and physical (PHY) layers. There is a standardized public interface F1 between gNB-CU and gNB-DU, and a standardized public interface W1 between ng-eNB-CU and ng-eNB-DU. The F1 interface is divided into a control plane F1-C and a user plane F1-U. The transport network layer of F1-C is based on IP transport. To transmit signaling more reliably, stream control transmission protocol (SCTP) protocol is added onto IP. The protocol of the application layer is F1 application protocol (F1AP). SCTP can provide reliable application layer message transmission. The transport layer of F1-U is UDP/IP, and the GPRS tunneling protocol-user plane (GTP-U) is used to carry the user plane protocol data unit (PDU) above UDP/IP.

FIG. 3B illustrates a BS according to an embodiment. Referring to FIG. 3B, the gNB-CU may include a gNB-CU-CP (control plane part of a centralized unit of a BS) and a gNB-CU-UP (user plane part of a centralized unit of a BS), a gNB-CU-CP contains functions of a control plane of a BS and has RRC and SDAP protocol layers, and a gNB-CU-UP contains functions of a user plane of a BS and has SDAP and PDCP protocol layers. There is a standardized public interface E1 between gNB-CU-CP and gNB-CU-UP, and the protocol is E1 Application Protocol (E1AP). The interface between the control plane part of the centralized unit of the BS and the DU of the BS is an F1-C interface, that is, the control plane interface of F1, and the interface between the user plane part of the centralized unit of the BS and the DU of the BS is an F1-U interface, that is, the user plane interface of F1. In the NR system, a BS providing the E-UTRA user plane and control plane which accessed a 5G core network is called ng-eNB. To support virtualization, such a BS (ng-eNB) may also be further divided into a centralized unit ng-eNB-CU (gNB CU/ng-eNB CU) and a DU ng-eNB-DU (gNB DU/ng-eNB DU) (abbreviated as CU and DU herein),

FIG. 3C illustrates a BS according to an embodiment. Referring to FIG. 3C. ng-eNB-CU has RRC and PDCP layers. gNB-DU/ng-eNB-DU has RLC protocol, MAC and physical layer. There is a standardized public interface W1 between ng-eNB-CU and ng-eNB-DU. The W1 interface is divided into a control plane W1-C and a user plane W1-U. The transport network layer of W1-C is based on IP transport. To transmit signaling more reliably, SCTP protocol is added onto IP. The protocol of the application layer is W1 Application Protocol (W1AP). The transport layer of W1-U is UDP/IP, and GTP-U is used to carry user plane PDU above UDP/IP.

A WAB node (or WAB) may include a WAB-gNB and a WAB-MT (mobile terminal).

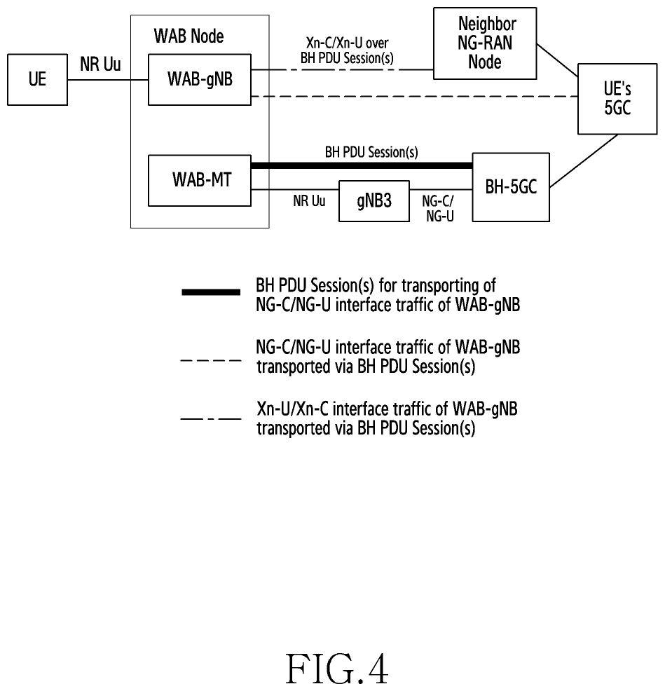

FIG. 4 illustrates a WAB node in a wireless communication system according to an embodiment.

Referring to FIG. 4:
the WAB-gNB provides communication services for UEs through an air interface (e.g., NR Uu);
the WAB-MT is connected to a backhaul (BH) radio access network node (BH-RAN-Node) (for example, BH gNB) through an air interface, thereby providing backhaul for the WAB-gNB;
the BH gNB is connected to a BH 5GC, which is a 5GC of the WAB-MT (WAB-MT's 5GC), and the BH gNB and the BH 5GC establish a BH PDU session for the WAB-MT;
the BH 5GC is connected to a 5GC of the UE (UE's 5GC), and the 5GC of the UE provides communication services for the UEs under the WAB-gNB;
the WAB-gNB transmits data for the UE with the UE's 5GC through the BH PDU session; and
the WAB-gNB establishes an NG interface (e.g., NG-C/NG-U) with the UE's 5GC through the BH PDU session, and establishes an Xn interface (e.g., Xn-C/Xn-U) with a neighbor BS through the BH PDU session.

WAB has mobility. WAB-MT can support at least part of UE functions, and WAB-gNB can be a complete BS. WAB-gNB can establish an Xn interface with other normal gNBs through BH PDU sessions, and also supports the existing Xn control plane transport network layer address discovery (Xn-C TNL address discovery) function.

The Xn-C TNL address discovery function is generally described as follows:

If an NG-RAN node knows the RAN node ID of a candidate NG-RAN node (e.g., through an automatic neighbor relation (ANR) function), but does not know a transport network layer (TNL) address suitable for a SCTP connection, then the NG-RAN node can determine the TNL address using 5GC (e.g., the AMF to which it is connected), an example process is as follows:

The NG-RAN node transmits an UPLINK RAN CONFIGURATION TRANSFER message to the AMF, requesting the TNL address of the candidate NG-RAN node and including a source RAN node ID, a target RAN node ID and other related information in the message;

The AMF relays the request by transmitting a DOWNLINK RAN CONFIGURATION TRANSFER message to the candidate NG-RAN node identified by the target RAN node ID;

The candidate NG-RAN node responds by transmitting an UPLINK RAN CONFIGURATION TRANSFER message, which may contain one or more TNL addresses used for the SCTP connection with the source NG-RAN node, and include other related information such as the source RAN node ID and the target RAN node ID, etc.;

The AMF relays the response by transmitting a DOWNLINK CONFIGURATION TRANSFER message to the source NG-RAN node.

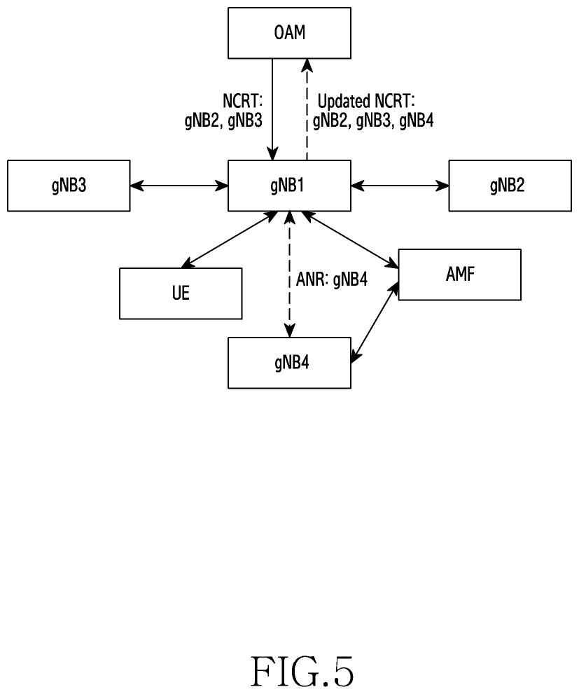

FIG. 5 illustrates when a normal gNB discovers a neighbor cell and establishes an Xn interface with the neighbor cell according to an embodiment. Referring to FIG. 5, the operation administration and maintenance (OAM) may configure gNB1 with a neighbor cell relation table (NCRT), which may include related information of the neighbor cells of gNB1 (e.g., gNB2 and gNB3). For example, the related information of the neighbor cells may include at least one of the following: target cell identity (TCI), global ID and/or physical ID (e.g., NR global cell identifier (CGI)/NR physical cell identifier (PCI), etc. gNB1 may establish neighbor cell relations and Xn interface connections with gNB2 and gNB3 according to NCRT. gNB1 may also configure measurement configuration for a UE it serves. If gNB1 finds that the existing neighbor cell list (for example, the PCI list) does not contain a PCI of gNB4 through the measurement report reported by the UE, and gNB1 expects to establish an Xn interface connection with gNB4, gNB1 may obtain the IP address of gNB4 through Xn-C TNL address discovery, and initiates an Xn setup procedure to gNB4. gNB1 may also feed back an updated NCRT back to the OAM. Therefore, OAM can configure gNB1 with related information of most of its neighbor gNBs through NCRT, and related information of only a few neighbor gNBs need to be supplemented by gNB1 through ANR.

Due to a WAB's mobility, however, OAM may be unable to timely provide the WAB with NCRT.

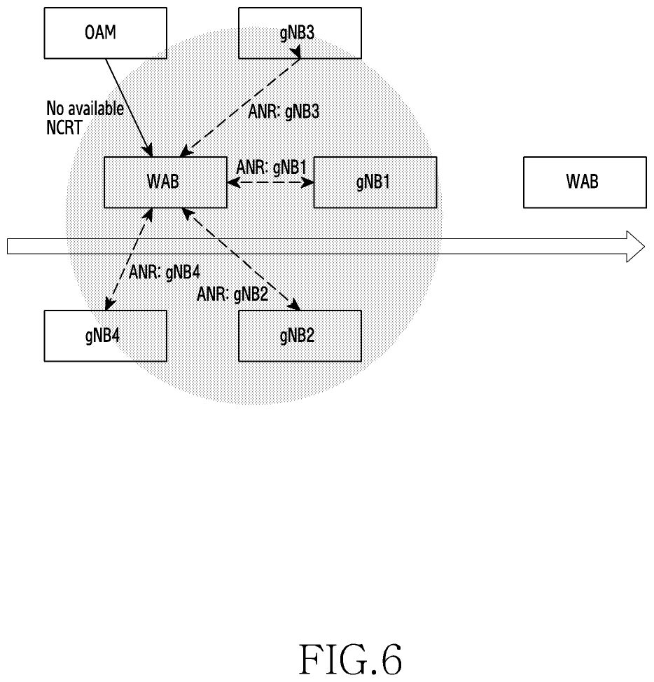

FIG. 6 illustrates when a WAB discovers neighbor gNBs during mobility according to an embodiment. Referring to FIG. 6, after the WAB moves to a certain area, the PCIs of all surrounding neighbor gNBs are not in the NCRT of the WAB, so the IP addresses of all neighbor gNBs need to be obtained by the WAB through the Xn-C TNL address discovery function. However, compared with the normal gNB performing the Xn-C TNL address discovery function in FIG. 5, the WAB performing the Xn-C TNL address discovery function will cause a larger delay.

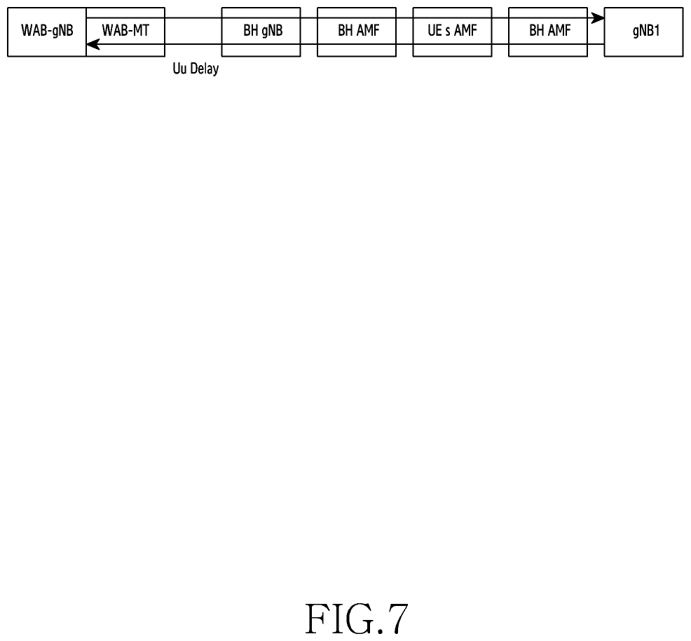

FIG. 7 illustrates message delivery for a WAB-gNB to obtain the IP address of gNB1 under the BH AMF according to an embodiment. Referring to FIG. 7, the AMF connected to the WAB-gNB is the UE's AMF, but not the BH AMF. Therefore, if the WAB-gNB wants to obtain the IP address of gNB1 under the BH AMF, the UPLINK RAN CONFIGURATION TRANSFER message transmitted by the WAB-gNB needs to pass through the BH gNB, BH AMF, and the UE's AMF in sequence, and then transmitted by the UE's AMF to the BH AMF, and finally transmitted by the BH AMF to gNB1; if gNB1 replies to the UPLINK RAN CONFIGURATION TRANSFER message, the reply also needs to pass through these network nodes in reverse. Therefore, the delay (especially the delay at the Uu interface) for the WAB to perform Xn-C TNL address discovery is much larger than the delay for a normal gNB to perform Xn-C TNL address discovery. Therefore, a case directed to in FIG. 6 in which the WAB may have moved to a farther place before establishing Xn interfaces with surrounding gNBs in time may occur. In this case, Xn interfaces may not be established in time, and UE handover based on the Xn interface may not be performed.

Therefore, disclosed is a method for obtaining an IP address of a BS, thereby enabling the WAB to more rapidly obtain the IP address of a neighbor gNB.

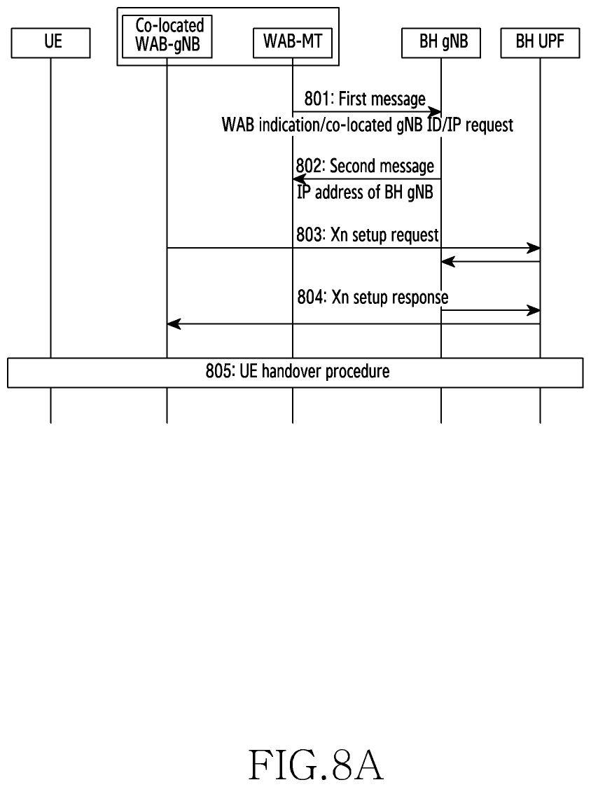

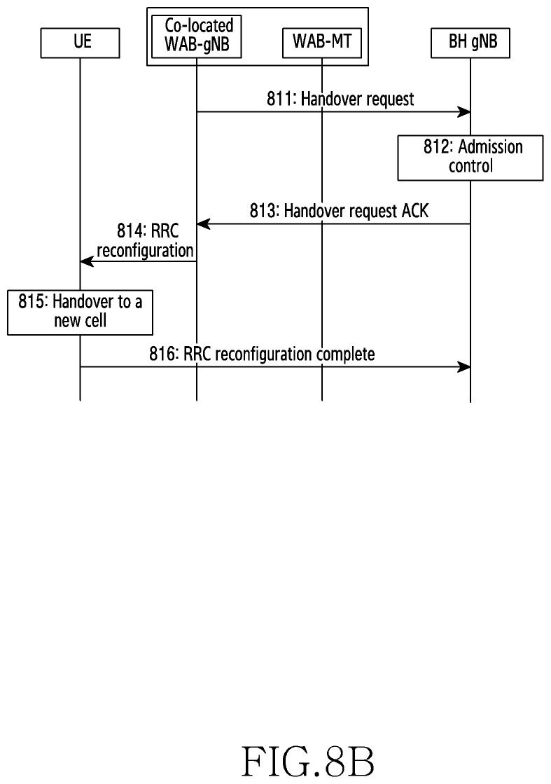

FIG. 8A illustrates a method of obtaining the IP addresses of BH gNB and its neighbor gNB according to an embodiment. Referring to FIG. 8A, this method is directed enabling a WAB to obtain the IP address of the BH gNB quickly, and make corresponding enhancements to the corresponding signaling processes therein.

When the WAB-gNB expects to establish an Xn interface with the BH gNB, in step 801, the WAB-MT may transmit a first message to the BH gNB, and first information may be added in the first message.

The first message may be Message 5 (Msg 5, i.e., RRC setup complete message), or other RRC messages (for example, UE assistance information message), etc., which is not limited herein.

The first information may include one or more of the following:
indication information of a WAB node/WAB-MT (e.g., information indicating that the MT is a WAB node or a WAB-MT);
an ID of a co-located WAB-gNB; and
request information for the IP address of the BH gNB (i.e., a request for the IP address of the BH gNB).

In step 802, after the BH gNB receives the first message transmitted by the WAB-MT, the BH gNB may add second information in the second message and transmit it to the WAB-MT.

The second message may be an RRC message, an RRC reconfiguration message, or other RRC messages, which are not limited in the present disclosure;

The second information may be or include the IP address of the BH gNB.

After the WAB-MT receives the second message carrying the second information, the WAB-gNB can know the IP address of the BH gNB. For example, the WAB-MT may further transmit or inform the second information to the co-located WAB-gNB.

In step 803, the WAB-gNB may initiate an Xn setup request to the BH gNB according to the IP address of the BH gNB, e.g., through a BH PDU session established by a Backhaul User Plane Function (BH UPF).

In step 804, after receiving the Xn setup request, the BH gNB may reply an Xn setup response to the WAB-gNB through the BH PDU session established by BH UPF.

In step 805, after the Xn connection setup between the WAB-gNB and the BH gNB is completed, the WAB-gNB can perform cell handover for the served UE. For example, the served UE may be handed over to a cell of the BH gNB.

FIG. 8B illustrates an example UE handover process according to an embodiment.

Referring to FIG. 8B, in step 811, the WAB-gNB (source gNB) initiates a handover and transmits a HANDOVER REQUEST to the BH gNB (target gNB) over the Xn interface.

In step 812, the BH gNB may perform admission control and may transmit a HANDOVER REQUEST ACKNOWLEDGE to the WAB-gNB in step 813, which may include new RRC configuration.

In step 814, the WAB-gNB may transmit an RRCReconfiguration message to the UE. For example, the WAB-gNB may provide RRC configuration to the UE by forwarding the RRC reconfiguration message received in the HANDOVER REQUEST ACKNOWLEDGE. The RRC reconfiguration message may include at least the cell ID and all information required to access the target cell, so that the UE can access the target cell without reading system information. In some cases, information required for contention-based random access and contention-free random access may be included in the RRC reconfiguration message. In some cases, the access information for accessing to the target cell may include beam specific information.

In step 815, the UE may move the RRC connection onto the BH gNB.

In step 816, the UE may reply or transmit an RRCReconfigurationComplete message to the BH gNB.

The UE handover process in FIG. 8A and subsequent drawings may refer to the example process of FIG. 8B, which is not limited by the present disclosure.

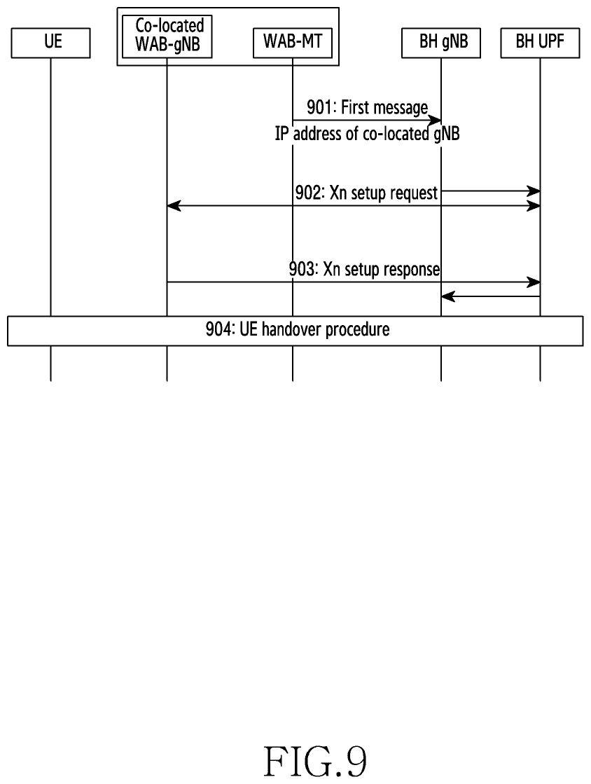

FIG. 9 illustrates a method of obtaining the IP addresses of BH gNB and its neighbor gNB according to an embodiment. Referring to FIG. 9, the Xn setup request can be initiated by the BH gNB actively.

If the WAB-gNB expects to establish an Xn interface with the BH gNB, it may perform the following example methods.

In step 901, the WAB-MT may transmit a first message to the BH gNB, and third information may be added in the first message.

The first message may be Message 5 (Msg 5, i.e., RRC setup complete message), or other RRC messages (for example, UE assistance information message), etc., which is not limited herein.

The third information may include one or more of the following:
indication information of a WAB node/WAB-MT;
an ID of the co-located WAB-gNB; and
an IP address of the co-located WAB-gNB.

In step 902, after receiving the first message carrying the third information, the BH gNB may actively transmit an Xn setup request to the WAB-gNB through a BH PDU session established by BH UPF.

In step 903, after receiving the Xn setup request, the WAB-gNB may reply with an Xn setup response to the BH gNB through a BH PDU session established by BH UPF.

In step 904, after the Xn connection setup between the WAB-gNB and the BH gNB is completed, the WAB-gNB can perform cell handover for the served UE. For example, the served UE may be handed over to a cell of the BH gNB.

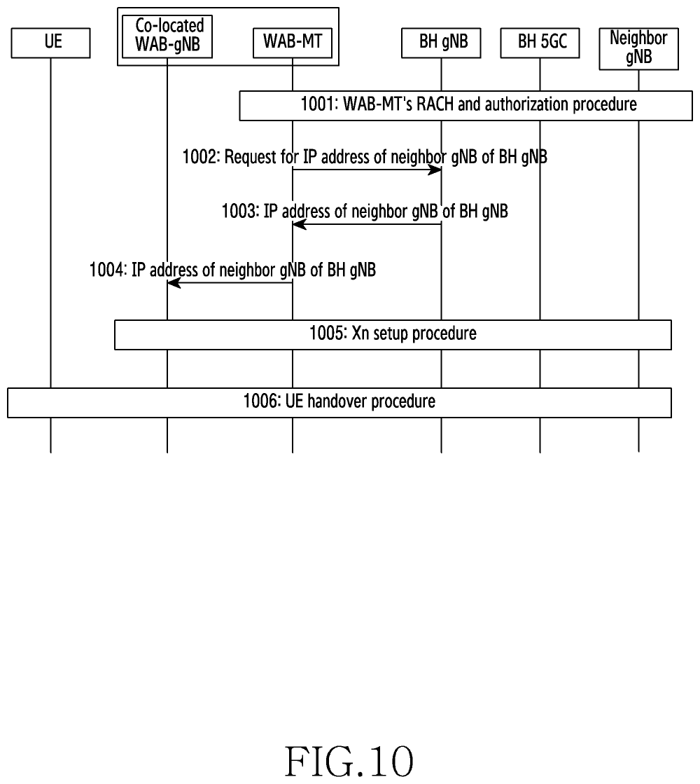

FIG. 10 illustrates a method of obtaining the IP addresses of BH gNB and its neighbor gNB according to an embodiment. Referring to FIG. 10, this method concerns how the WAB obtains an IP address of a neighbor gNB. The co-located WAB-gNB may treat the neighbor gNBs of the BH gNB as the WAB-gNB's own neighbor gNBs; or in another word, the co-located WAB-gNB may serve the neighbor gNBs of the BH gNB as references and treat all or part of the neighbor gNBs of the BH gNB as the WAB-gNB's own neighbor gNBs. Example processes and/or corresponding signaling enhancements are described below.

In step 1001, the WAB-MT may perform a random access (RACH) process with the BH gNB and the BH 5GC (e.g., BH AMF) may perform an authorization process on the WAB-MT.

If the co-located WAB-gNB expects to establish an Xn interface with other neighbor gNBs, in step 1002, the WAB-MT may add fourth information in the third message and transmit it to the BH gNB.

The third message may be an RRC message, a UE assistance information message, or other RRC messages, which are not limited in the present disclosure.

The fourth information may be or include request information for IP addresses of neighbor gNBs of the BH gNB (e.g., a request for IP addresses of neighbor gNBs of the BH gNB).

In step 1003, the BH gNB may add fifth information in the fourth message and transmit it to the WAB-MT.

The fourth message may be an RRC message, an RRC reconfiguration message, or other RRC messages, which are not limited in the present disclosure.

The fifth information may be or include IP addresses of neighbor gNBs of the BH gNB.

After the WAB-MT receives the fourth message carrying the fifth information, the co-located WAB-gNB can know the IP addresses of the neighbor gNBs of the BH gNB.

In step 1004, the WAB-MT may further transmit or inform the fifth information to the co-located WAB-gNB.

In step 1005, the co-located WAB-gNB may establish an Xn interface connection with the neighbor gNB of the BH gNB according to the IP address of the neighbor gNB of the BH gNB by transmitting an Xn setup request to the neighbor gNB of the BH gNB, etc.

In step 1006, after the Xn connection setup is completed, the WAB-gNB can perform cell handover for the served UE. For example, the served UE may be handed over to a cell of a neighbor gNB of the BH gNB.

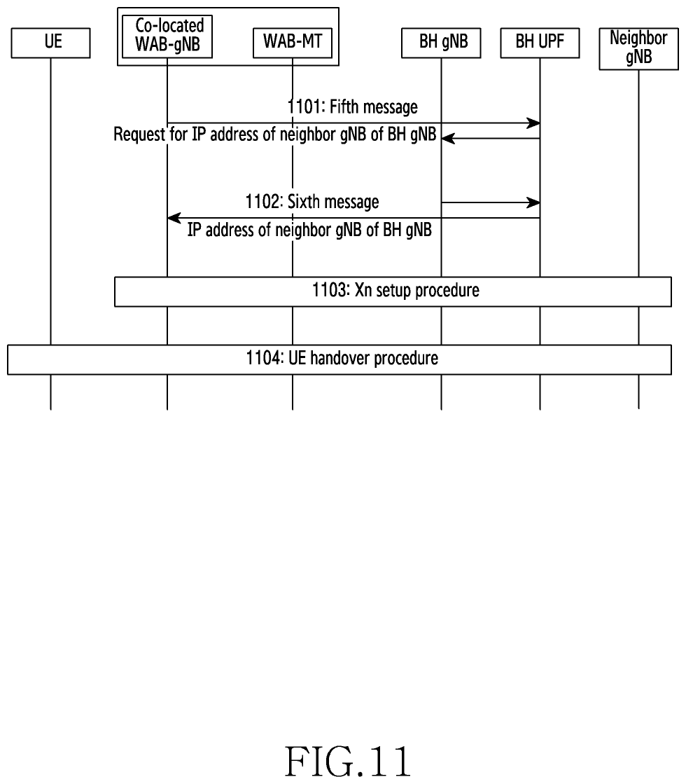

FIG. 11 illustrates a method of obtaining the IP addresses of BH gNB and its neighbor gNB according to an embodiment. Referring to FIG. 11, the co-located WAB-gNB may directly ask the BH gNB for the IP address of the BH gNB's neighbor gNB through an Xn interface.

In step 1101, when the BH PDU session setup is completed, the co-located WAB-gNB may initiate an Xn setup procedure to the BH gNB over the BH PDU session (e.g., through the BH PDU session established by BH UPF). The co-located WAB-gNB may add the fourth information in the fifth message and transmit it to the BH gNB.

The fifth message may be an Xn setup request message.

The fourth information may be or include request information of an IP address of a neighbor gNB of the BH gNB. The fourth information may also implicitly indicate that the co-located WAB-gNB is to handle the neighbor gNB of the BH gNB as its own neighbor gNB.

In step 1102, after the BH gNB receives the fifth message, the BH gNB may add the fifth information in a sixth message and reply it to the co-located WAB-gNB through a BH PDU session established by BH UPF.

The sixth message may be an Xn setup response message.

The fifth information may be or include the IP address of the neighbor gNB of the BH gNB.

In step 1103, the co-located WAB-gNB may establish an Xn interface connection with the neighbor gNB of the BH gNB according to the IP address of the neighbor gNB of the BH gNB by transmitting an Xn setup request to the neighbor gNB of the BH gNB, etc.

In step 1104, after the Xn connection setup is completed, the WAB-gNB can perform cell handover for the served UE. For example, the served UE may be handed over to a cell of a neighbor gNB of the BH gNB.

In this embodiment, the co-located WAB-gNB asks the BH gNB for the IP address of the neighbor gNB of the BH gNB during the Xn setup procedure. If the Xn setup procedure is completed, the co-located WAB-gNB can also ask the BH gNB for the IP address of the neighbor gNB of the BH gNB through Xn interface related messages or signaling. In this case, the fifth message and the sixth message may be Xn interface related messages. For example, the fifth message may be a NG-RAN node Configuration Update message, and the sixth message may be a NG-RAN NODE CONFIGURATION UPDATE ACKNOWLEDGE message, or they can also be other Xn interface related messages, which are not limited in the present disclosure.

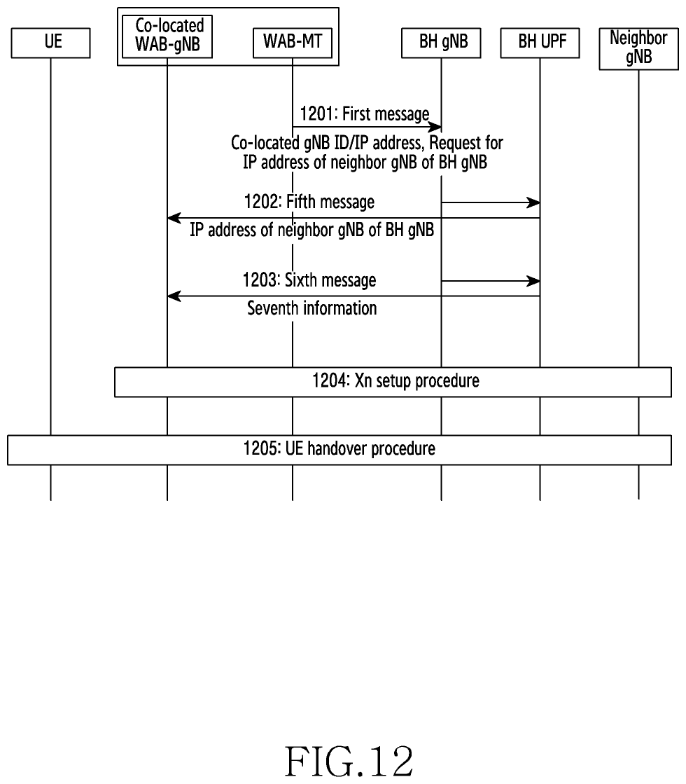

FIG. 12 illustrates a method of obtaining the IP addresses of BH gNB and its neighbor gNB according to an embodiment. Referring to FIG. 12, a method is provided for the WAB to obtain the IP address of the neighbor gNB.

In step 1201, if the co-located WAB-gNB expects to establish an Xn interface with other neighbor gNBs, the WAB-MT may add the sixth information in the first message to the BH gNB.

The first message may be Message 5 (Msg 5, i.e., RRC setup complete message), or other RRC messages (for example, UE assistance information message), etc., which is not limited herein.

The sixth information may include one or more of the following:
indication information of a WAB node/WAB-MT;
an ID and/or IP address of the co-located WAB-gNB; and
request information for an IP address of a neighbor gNB of the BH gNB.

In step 1202, after receiving the first message and after the BH PDU session setup is completed, the BH gNB may transmit a fifth message (for example, through a BH PDU session established by BH UPF) to the co-located WAB-gNB according to the sixth information. session), where the fifth message may include fifth information.

The fifth message may be an Xn setup request message.

The fifth information may be or include an IP address of the neighbor gNB of the BH gNB.

In step 1203, after receiving the fifth message, the co-located WAB-gNB may reply a sixth message to the BH gNB through a BH PDU session established by BH UPF. The co-located WAB-gNB may not add its neighbor node list (e.g., a Neighbor NG-RAN Node List IE) in the sixth message, but may reply to the BH gNB with seventh information added in the sixth message.

The sixth message may be an Xn setup response message.

The seventh information may indicate to the BH gNB that the neighbor node list (e.g., Neighbor NG-RAN Node List IE) of the co-located WAB-gNB is the same as that of the BH gNB. For example, the seventh information may include information indicating that the neighbor node list of the co-located WAB-gNB is the same as the neighbor node list of the BH gNB.

In step 1204, the co-located WAB-gNB may establish an Xn interface connection with the neighbor gNB of the BH gNB according to the IP address of the neighbor gNB of the BH gNB by transmitting an Xn setup request to the neighbor gNB of the BH gNB, etc.

In step 1205, after the Xn connection setup is completed, the WAB-gNB can perform cell handover for the served UE. For example, the served UE may be handed over to a cell of a neighbor gNB of the BH gNB.

Any one or more of these embodiments and their related messages or information provided by the present disclosure can also be implemented in combination. For example, in the first embodiment, the WAB-MT may ask the BH gNB for the IP addresses of the BH gNB and its neighbor gNB through a first message simultaneously;. The BH gNB may transmit the IP addresses of the BH gNB and its neighbor gNB together to the WAB-MT through a second message. In this case, the first information may include not only the request information for the IP address of the BH gNB but may also include the request information for the IP address of the neighbor gNB of the BH gNB in the sixth information. The sixth information may include not only the request information for the IP address of the neighbor gNB of the BH gNB but may also include the request information for the IP address of the BH gNB in the first information, and so on. Each field or information element in each piece of information can also be used in combination with each other, which is not limited by the present disclosure. The case in which various such embodiments and their related messages or information contents are implemented together is not limited in the present disclosure and will not be described again hereinafter.

The second aspect: exchange of WAB-related information

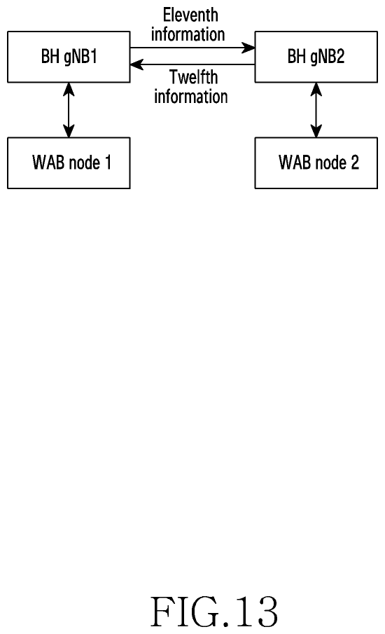

FIG. 13 illustrates an example scenario of network connection according to an embodiment. Referring to FIG. 13, such a network connection indicating that Xn interfaces are established between WAB node 1 and BH gNB1, between BH gNB1 and BH gNB2, and between BH gNB2 and WAB node 2, but Xn interface is not established between BH gNB1 and WAB node 2, and between BH gNB2 and WAB node 1.

If information on whether a node or cell (e.g., a message transmitting node or cell) is a WAB node or a WAB cell is exchanged during the Xn setup procedure (i.e., the WAB node indication or WAB cell indication is added in the Xn setup request and/or Xn setup response), then: BH gNB1 can know that WAB node 1 is a WAB node, and can know that BH gNB2 is not a WAB node; BH gNB2 can know that WAB node 2 is a WAB node, and can know that BH gNB1 is not a WAB node. But BH gNB1 does not know that WAB node 2 is a WAB node, and similarly BH gNB2 does not know that WAB node 1 is a WAB node. This may result in the following scenario: BH gNB1 may hand over WAB-MTI in WAB node 1 to WAB-gNB2 in WAB node 2. However, the WAB-MT should not be handed over to the WAB-gNB by the BH gNB, so to avoid such a problem, the following signaling enhancements may be performed.

When an Xn interface is established between gNBs (BH gNB1 and BH gNB2 in FIG. 13), the indication information on whether the neighbor node/cell is a WAB node/cell may be added in relevant messages or signaling (e.g., Xn setup request and/or Xn setup response, etc.), as shown in Table 1 below.

TABLE 1

| | | | |
|---|---|---|---|
| | 0 . . . | | |
| Neighbour NG- | <maxnoofNeighbourNG- | | |
| RAN Node List | RAN nodes> | YES | Ignore |

| | | | |
|---|---|---|---|
| >Global NG- | M | 9.2.2.3 | — |
| RAN Node ID | | | |
| >Local NG- | M | 9.2.2.101 | — |
| RAN Node | | | |
| Identifier | | | |
| >WAB node | O | ENUMERATED | |
| (WAB Node) | | (true, . . .) | |

In Table 1, the BH gNB1 may add indication information in the Xn setup request indicating which neighbor NG-RAN nodes in its neighbor node list (e.g. Neighbor NG-RAN Node List IE) are WAB nodes, and transmit it to the BH gNB2. BH gNB1 may transmit eleventh information to BH gNB2, which may be information on which neighbor nodes among the neighbor nodes of BH gNB1 or which neighbor nodes in the neighbor node list are WAB nodes. For example, the eleventh information may include a neighbor node list of BH gNB1, where the neighbor node list includes information on whether each neighbor node therein is a WAB node.

After receiving the Xn setup request, the BH gNB2 may also add indication information in the Xn setup response indicating which neighbor NG-RAN nodes in its neighbor node list (e.g. Neighbor NG-RAN Node List IE) are WAB nodes, and send it back to the BH gNB1. More generally, BH gNB2 may transmit to BH gNB1 twelfth information, which may be information on which neighbor nodes among the neighbor nodes of BH gNB2 or which neighbor nodes in the neighbor node list are WAB nodes.

The above-mentioned method of transmitting eleventh information through an Xn setup request message and transmitting twelfth information through an Xn setup response message is only an example. The eleventh information and/or the twelfth information may also be transmitted by any other Xn interface related message in addition to the Xn setup request message and/or the Xn setup response message, e.g. by NG-RAN node Configuration Update and/or NG-RAN NODE CONFIGURATION UPDATE ACKNOWLEDGE. etc., which is not limited herein.

Through the above embodiments, BH gNB1 may know that WAB node 2 is a WAB node, and similarly, BH gNB2 may also know that WAB node 1 is a WAB node. Therefore, BH gNB1 would not handover WAB-MTI in WAB node 1 to WAB-gNB2 in WAB node 2; and similarly, BH gNB2 would also not handover WAB-MT2 in WAB node 2 to WAB-gNB1 in WAB node 1.

The third aspect: optimization of a WAB-MT handover process

Because the connection of a control plane Xn interface (Xn-C interface) is implemented through a BH PDU session, if the WAB-gNB wants to perform UE handover based on the Xn interface with the BH gNB/neighbor gNB, signaling exchanging between the WAB-gNB and the BH gNB/neighbor gNB needs to be completed through the following entities, such as:
if a WAB-gNB wants to perform handover for a certain UE it serves, it needs to transmit a handover request (HO request) to a BH gNB through a WAB-MT;
the BH gNB then transmits the handover request to a BH UPF (for example, included in the BH-5GC in FIG. 4);
the BH UPF transmits the handover request to the BH gNB/neighbor gNB through IP routing;
if the BH gNB/neighbor gNB agrees with the handover request, a handover request acknowledge (HO request ACK) needs to be transmitted to the BH UPF;
the BH UPF then transmits the handover request ACK to the BH gNB;
the BH gNB then transmits the handover request ACK to the WAB-gNB through the WAB-MT; and
the WAB-gNB then transmits an RRC Reconfiguration message/HO command to the UE.

Thus, for a WAB-gNB, even if Xn-based handover (Xn based HO) is performed, the above steps need to be performed, which will cause a large delay and further lead to the failure of UE handover. Therefore, to simplify UE handover, disclosed is the following method to achieve a purpose of reducing UE handover delay.

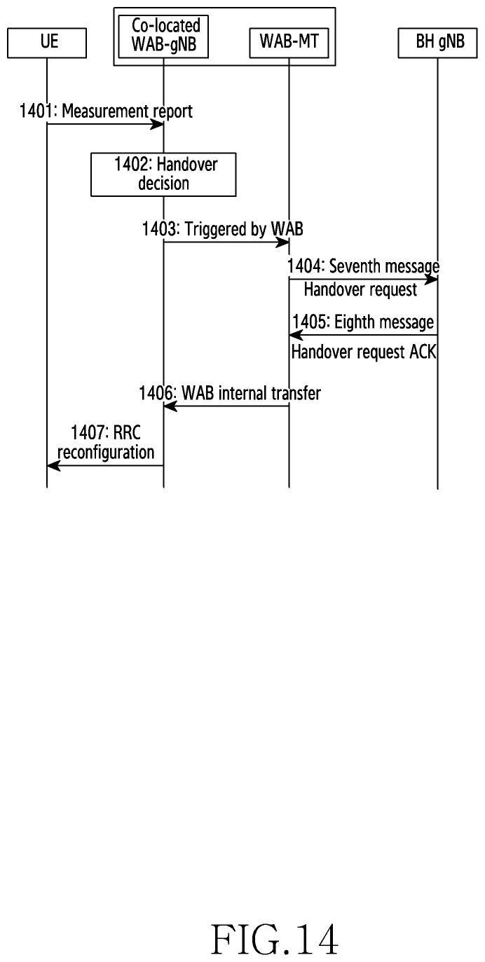

FIG. 14 illustrates an example scenario 1 in which a WAB-gNB hands over a UE to a BH gNB according to an embodiment. Referring to FIG. 14, example steps are as follows.

In step 1401, the UE reports a measurement report to the WAB-gNB.

In step 1402, the WAB-gNB decides to perform handover for the UE based on the measurement report of the UE decides to handover the UE to the BH gNB.

In step 1403, the WAB-gNB may trigger the WAB-MT to transmit a seventh message to the BH gNB through implementation.

In step 1404, the WAB-MT may transmit a seventh message to the BH gNB.

The seventh message may be an RRC message it may be an existing RRC message or a newly defined RRC message, which is not limited in the present disclosure.

The seventh message may include a handover request transmitted by the WAB-gNB to the BH gNB. Optionally, the handover request may be included in an RRC container.

In step 1405, after receiving the seventh message, the BH gNB may reply to the WAB-MT with an eighth message.

The eighth message may be an RRC message it may be an existing RRC message or a newly defined RRC message, which is not limited in the present disclosure.

The eighth message may include a handover request acknowledge message or a handover preparation failure message that the BH gNB replies to the WAB-gNB. Optionally, the handover request acknowledge message or the handover preparation failure message may be included in an RRC container.

In step 1406, the WAB-MT may transmit the eighth message to the WAB-gNB through implementation.

In step 1407, if the eighth message is a handover request acknowledge, the WAB-gNB may transmit a handover command (HO command)/RRC reconfiguration message to the UE. If the eighth message is a handover preparation failure, the WAB-gNB may select another target gNB, or not perform UE handover.

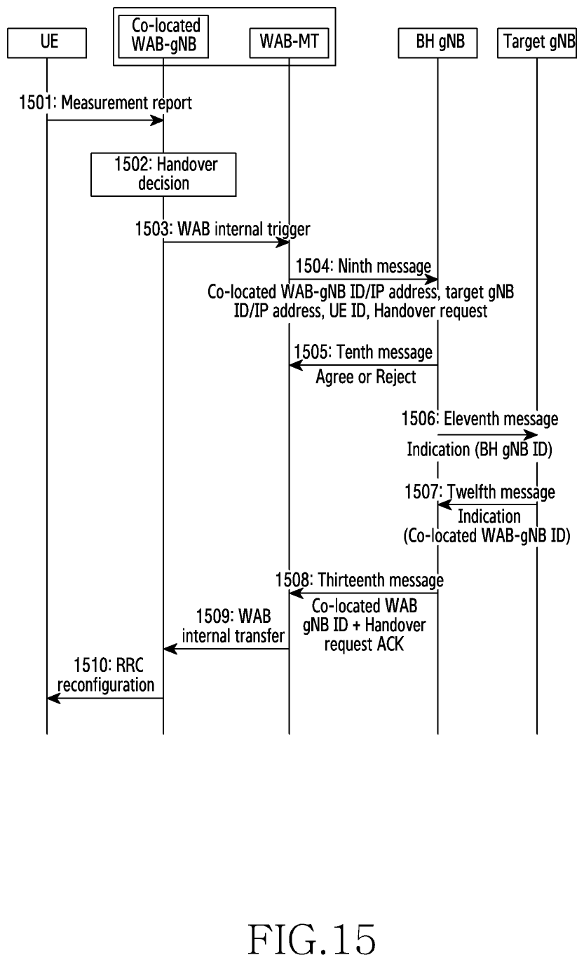

FIG. 15 illustrates an example scenario 2 in which a WAB-gNB hands over a UE to a neighbor gNB according to an embodiment. Referring to FIG. 15, the specific steps are as follows.

In step 1501, the UE reports a measurement report to the WAB-gNB.

In step 1502, the WAB-gNB decides to perform handover for the UE based on the measurement report of the UE decides to handover the UE to a neighbor gNB (for example, the target gNB in FIG. 15).

In step 1503, the WAB-gNB may trigger the WAB-MT to transmit a ninth message to the BH gNB through implementation.

In step 1504, the WAB-MT may transmit a ninth message to the BH gNB.

The ninth message may be an existing RRC message or a newly defined RRC message, which is not limited in the disclosure.

The ninth message may include at least one of the following:
an ID and/or IP address of a co-located WAB-gNB;
an ID and/or IP address of a target gNB;
an ID of a UE for which cell handover is to be performed; and
a handover request transmitted by the WAB-gNB to the target gNB. Optionally, the handover request may be included in an RRC container.

In step 1505, after receiving the ninth message, the BH gNB may send a tenth message to the WAB-MT.

The tenth message may be an existing RRC message or a newly defined RRC message, which is not limited in the present disclosure.

The tenth message may be used to indicate to the WAB-MT whether the BH gNB agrees to transmit a handover request to the target gNB for the WAB-gNB. For example, the content of the tenth message may be Agree (or ACK) or Reject. In other words, the tenth message may include information on whether the BH gNB agrees to transmit the handover request of the WAB-gNB to the target gNB.

In step 1506, if the BH gNB agrees to transmit the handover request of the WAB-gNB to the target gNB, the BH gNB may transmit an eleventh message to the target gNB.

The eleventh message may be an Xn interface related message or signaling. For example, it may be an existing Xn interface message, such as a handover request message, or a newly defined Xn interface message, which is not limited herein.

The eleventh message may include a handover request transmitted by the WAB-gNB to the target gNB.

The eleventh message may also carry eighth information, which may indicate the target gNB to transmit a handover request acknowledge message or a handover preparation failure message to the BH gNB but not the co-located WAB-gNB. For example, the eighth information may be or include information on transmitting a handover request acknowledge message or a handover preparation failure message to the BH gNB (instead of the co-located WAB-gNB).

In step 1507, the target gNB may send a twelfth message to the BH gNB.

The twelfth message may be an existing Xn interface message, such as a handover request acknowledge message or a handover preparation failure message, or a newly defined Xn interface message., which is not limited herein.

The twelfth message may include a handover request acknowledge or handover preparation failure transmitted by the target gNB for the handover request of the WAB-gNB.

The twelfth message may also carry ninth information, which may indicate the BH gNB to transmit a handover request acknowledge message or a handover preparation failure message to the co-located WAB-gNB. For example, the ninth information may be or include information on transmitting a handover request acknowledge message or a handover preparation failure message to the co-located WAB-gNB.

In step 1508, after receiving the twelfth message, the BH gNB may transmit a thirteenth message to the WAB-MT.

The thirteenth message may be an existing RRC message or a newly defined RRC message, which is not limited in the present disclosure.

The thirteenth message may carry a handover request acknowledge or handover preparation failure transmitted by the target gNB to the co-located WAB-gNB.

The thirteenth message may also carry tenth information, which may indicate the WAB-MT to transmit the thirteenth message to the co-located WAB-gNB. For example, the tenth information may be or include information on transmitting a handover request acknowledge or a handover preparation failure transmitted by the target gNB to the co-located WAB-gNB to the co-located WAB-gNB.

In step 1509, the WAB-MT may transmit the thirteenth message to the co-located WAB-gNB through implementation.

In step 1510, the co-located WAB-gNB may transmit a handover command (HO command)/RRC reconfiguration message to the UE.

In the example scenario 1 and the example scenario 2 as described above, the handover request transmitted by the co-located WAB-gNB is transmitted through an RRC message of the WAB-MT, which is a HO procedure based on signal radio bearer (SRB). The HO procedure may also be performed based on data radio bearer (DRB). Taking the example scenario 2 as an example (i.e., assuming that the UE is to be handed over to a neighbor gNB), the DRB-based scheme has a similar process to the SRB-based scheme, and the only differences are:
1) WAB-MT transmits data messages to BH gNB instead of signalling messages;
2) the BH gNB does not read the data, and just directly forwards the data messages received from the WAB-MT to the target gNB as a relay;
3) the handover request transmitted by the co-located WAB-gNB needs to be packaged in a PDU data packet;
4) the IP address of the target gNB and/or the IP address of the WAB-gNB (the IP address of the WAB-gNB being the IP address of the source gNB) is added in the GTP-U header in the packet;
5) when the target gNB sends a handover request acknowledge message or a handover preparation failure message, the message needs to be packaged in a PDU data packet, and transmitted to the co-located WAB-gNB through BH gNB and WAB-MT. The target gNB also needs to add the IP address of the WAB-gNB and/or the IP address of the target gNB in the GTP-U header of the data packet.

Depending on the application scenario, the various embodiments, example aspects, methods, steps, processes, etc. shown above in conjunction with the drawings can be implemented individually or combined in any manner, which is not limited herein.

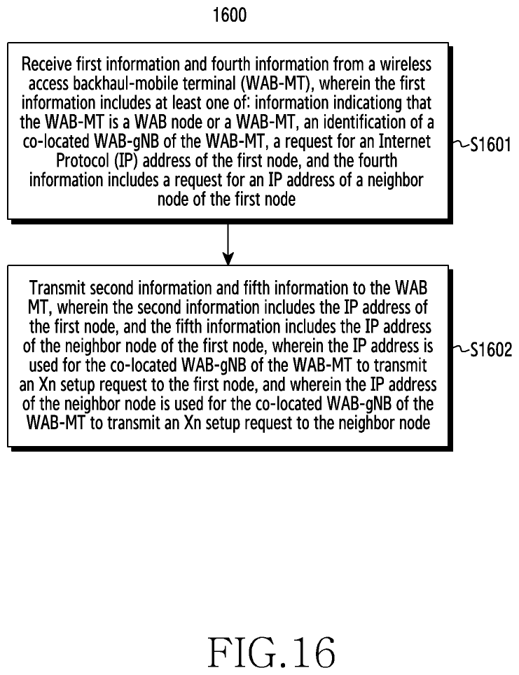

FIG. 16 illustrates a method 1600 performed by a first node in a wireless communication system according to an embodiment.

Referring to FIG. 16 a method 1600 performed by a first node in a wireless communication system includes in step S1601 receiving first information and fourth information from a wireless access backhaul-mobile terminal (WAB-MT) wherein the first information includes at least one of information indicating that the WAB-MT is a WAB node or a WAB-MT an identification of a co-located WAB-gNB of the WAB-MT a request for an IP address of the first node and the fourth information includes a request for an IP address of a neighbor node of the first node; and in step S1602 transmitting second information and fifth information to the WAB-MT wherein the second information includes the IP address of the first node and the fifth information includes the IP address of the neighbor node of the first node wherein the IP address is used for the co-located WAB-gNB of the WAB-MT to transmit an Xn setup request to the first node and wherein the IP address of the neighbor node is used for the co-located WAB-gNB of the WAB-MT to transmit an Xn setup request to the neighbor node.

The method further includes receiving third information from the WAB-MT wherein the third information includes an IP address of the co-located WAB-gNB of the WAB-MT; and transmitting an Xn setup request to the co-located WAB-gNB of the WAB-MT based on the IP address of the co-located WAB-gNB of the WAB-MT.

The method further includes receiving sixth information from the WAB-MT wherein the sixth information includes at least one of information indicating that the WAB-MT is a WAB node or a WAB-MT an identification and/or an IP address of a co-located WAB-gNB of the WAB-MT a request for an IP address of a neighbor node of the first node; transmitting fifth information to the co-located WAB-gNB of the WAB-MT wherein the fifth information includes the IP address of the neighbor node of the first node; and receiving seventh information from a co-located WAB-gNB of the WAB-MT wherein the seventh information includes information indicating that a neighbor node list of the co-located WAB-gNB is the same as a neighbor node list of the first node.

The method further includes receiving fourth information from a co-located WAB-gNB of the WAB-MT wherein the fourth information includes a request for an IP address of a neighbor node of the first node; transmitting fifth information to the co-located WAB-gNB wherein the fifth information includes the IP address of the neighbor node of the first node wherein the IP address of the neighbor node of the first node is used for the co-located WAB-gNB to transmit an Xn setup request to the neighbor node of the first node.

The method further includes transmitting an eleventh information to a second node wherein the eleventh information includes a first neighbor node list of the first node wherein the first neighbor node list includes information on whether each neighbor node in the first neighbor node list is a WAB node; and receiving a twelfth information from the second node wherein the twelfth information includes a second neighbor node list of the second node wherein the second neighbor node list includes information on whether each neighbor node in the second neighbor node list is a WAB node.

The method further includes receiving a seventh message from the WAB-MT wherein the seventh message includes a handover request transmitted by the co-located WAB-gNB to the first node, and transmitting an eighth message to the WAB-MT wherein the eighth message includes a handover request acknowledge message or a handover preparation failure message transmitted by the first node to the co-located WAB-gNB.

The method further includes receiving a ninth message from the WAB-MT wherein the ninth message includes at least one of an identification and/or an IP address of a co-located WAB-gNB of the WAB-MT an identification and/or an IP address of a target node an identification of a UE for which cell handover is to be performed a handover request of the co-located WAB-gNB, transmitting a tenth message to the WAB-MT wherein the tenth message includes information on whether the first node agrees to transmit the handover request of the co-located WAB-gNB to the target node, transmitting an eleventh message to the target node wherein the eleventh message includes a handover request of the co-located WAB-gNB and eighth information on transmitting a handover request acknowledge or handover preparation failure for the handover request to the first node, receiving a twelfth message from the target node wherein the twelfth message includes a handover request acknowledge or handover preparation failure for the handover request and ninth information on transmitting the handover request acknowledge or handover preparation failure to the co-located WAB-gNB, and transmitting a thirteenth message to the WAB-MT wherein the thirteenth message includes the handover request acknowledge or handover preparation failure and tenth information on transmitting the handover request acknowledge or handover preparation failure to the co-located WAB-gNB.

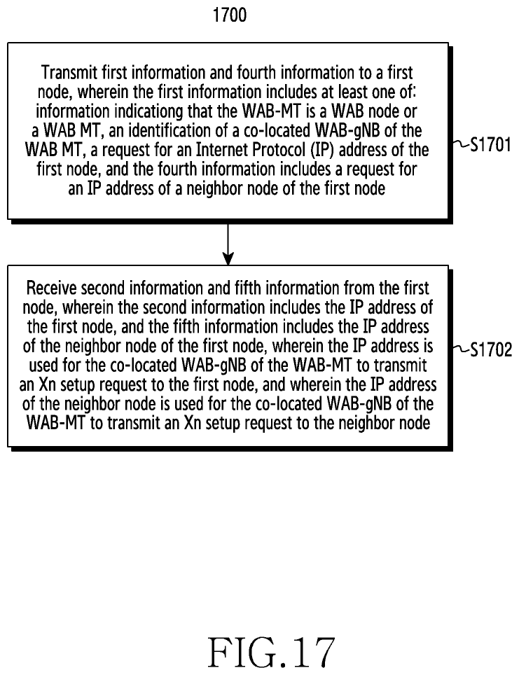

FIG. 17 illustrates a method 1700 performed by a WAB-MT in a wireless communication system according to an embodiment.

Referring to FIG. 17, the method 1700 includes, in step S1701, transmitting first information and fourth information to a first node, wherein the first information includes at least one of information indicating that the WAB-MT is a WAB node or a WAB-MT, an identification of a co-located WAB-gNB of the WAB-MT, a request for an IP address of the first node, and the fourth information includes a request for an IP address of a neighbor node of the first node, and in step S1702, receiving second information and fifth information from the first node, wherein the second information includes the IP address of the first node, and the fifth information includes the IP address of the neighbor node of the first node, wherein the IP address is used for the co-located WAB-gNB of the WAB-MT to transmit an Xn setup request to the first node, and wherein the IP address of the neighbor node is used for the co-located WAB-gNB of the WAB-MT to transmit an Xn setup request to the neighbor node.

The method further includes transmitting the IP address of the neighbor node of the first node to the co-located WAB-gNB of the WAB-MT.

The method further includes transmitting third information to the first node, wherein the third information includes an IP address of the co-located WAB-gNB of the WAB-MT, wherein the IP address of the co-located WAB-gNB of the WAB-MT is used by the first node to transmit an Xn setup request to the co-located WAB-gNB of the WAB-MT.

The method further includes transmitting sixth information to the first node, wherein the sixth information includes at least one of information indicating that the WAB-MT is a WAB node or a WAB-MT, an identification and/or an IP address of a co-located WAB-gNB of the WAB-MT, a request for an IP address of a neighbor node of the first node, wherein fifth information is transmitted by the first node to the co-located WAB-gNB of the WAB-MT, wherein the fifth information includes the IP address of the neighbor node of the first node, and wherein seventh information is transmitted by the co-located WAB-gNB of the WAB-MT to the first node, wherein the seventh information includes information indicating that a neighbor node list of the co-located WAB-gNB is the same as a neighbor node list of the first node.

The method further includes transmitting a seventh message to the first node, wherein the seventh message includes a handover request transmitted by the co-located WAB-gNB to the first node, and receiving an eighth message from the first node, wherein the eighth message includes a handover request acknowledge message or a handover preparation failure message transmitted by the first node to the co-located WAB-gNB.

The method further includes transmitting a ninth message to the first node, wherein the ninth message includes at least one of an identification and/or an IP address of a co-located WAB-gNB of the WAB-MT, an identification and/or an IP address of a target node, an identification of a UE for which cell handover is to be performed, a handover request of the co-located WAB-gNB, receiving a tenth message from the first node, wherein the tenth message includes information on whether the first node agrees to transmit the handover request of the co-located WAB-gNB to the target node, and receiving a thirteenth message from the first node, wherein the thirteenth message includes a handover request acknowledge or handover preparation failure for the handover request transmitted by the target node, and tenth information on transmitting the handover request acknowledge or handover preparation failure to the co-located WAB-gNB.

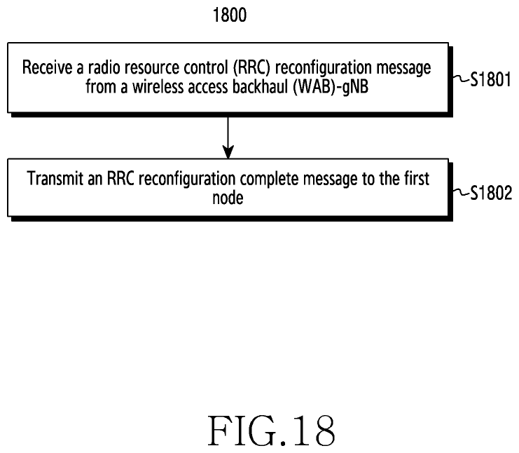

FIG. 18 illustrates a method 1800 performed by a UE in a wireless communication system according to an embodiment.

Referring to FIG. 18, the method 1800 includes, in step S1801, receiving a RRC reconfiguration message from a WAB-gNB, and in step S1802, transmitting an RRC reconfiguration complete message to the first node.

In some implementations, first and fourth information are transmitted from a co-located wireless access backhaul-mobile terminal (WAB-MT) of the WAB-gNB to the first node, wherein the first information includes at least one of information indicating that the WAB-MT is a WAB node or a WAB-MT, an identification of the WAB-gNB, a request for an IP address of the first node, and the fourth information includes a request for an IP address of a neighbor node of the first node.

In some implementations, second information and fifth information are transmitted from the first node to the WAB-MT, wherein the second information includes the IP address of the first node and the fifth information includes the IP address of the neighbor node of the first node.

The IP address is used for the WAB-gNB to transmit an Xn setup request to the first node. The IP address of the neighbor node is used for the co-located WAB-gNB to transmit an Xn setup request to the neighbor node.

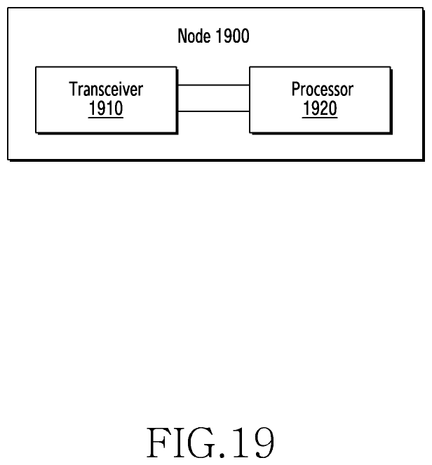

FIG. 19 illustrates a node 1900 in a wireless communication system according to an embodiment.

Referring to FIG. 19, a node 1900 may include a transceiver 1910 and a processor 1920. The transceiver 1910 may be configured to transmit and receive signals. The processor 1920 may be coupled to the transceiver 1910 and may be configured to (e.g., control the transceiver 1910 to) perform any of the methods performed by any node in the wireless communication system according to an embodiment.

Herein, a node may also be referred to as a node device. Herein, a processor may also be referred to as a controller.

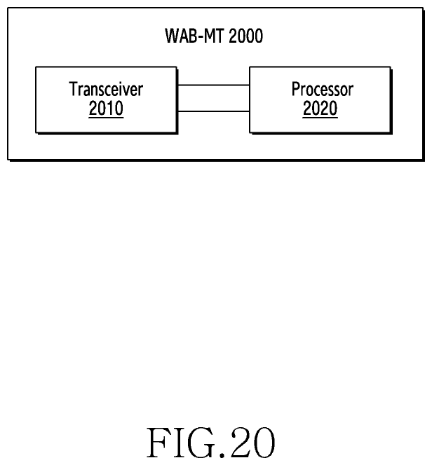

FIG. 20 illustrates a WAB-MT 2000 in a wireless communication system according to an embodiment.

Referring to FIG. 20, the WAB-MT 2000 may include a transceiver 2010 and a processor 2020. The transceiver 2010 may be configured to transmit and receive signals. The processor 2020 may be coupled to the transceiver 2010 and may be configured to (e.g., control transceiver 2010 to) perform any method performed by a WAB-MT in a wireless communication system according to an embodiment.

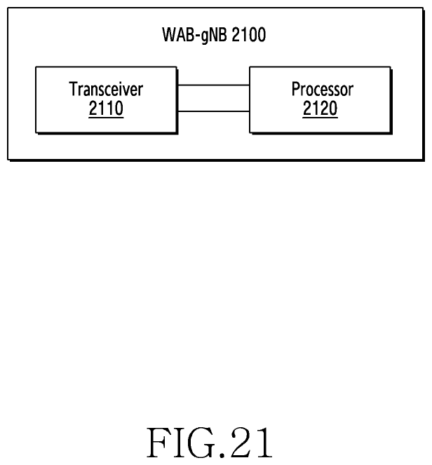

FIG. 21 illustrates a WAB-gNB2100 in a wireless communication system according to an embodiment.

Referring to FIG. 21, the WAB-gNB2100 may include a transceiver 2110 and a processor 2120. The transceiver 2110 may be configured to transmit and receive signals. The processor 2120 may be coupled to the transceiver 2110 and may be configured to (e.g., control transceiver 2110 to) perform any method performed by a WAB-gNB in a wireless communication system according to an embodiment.

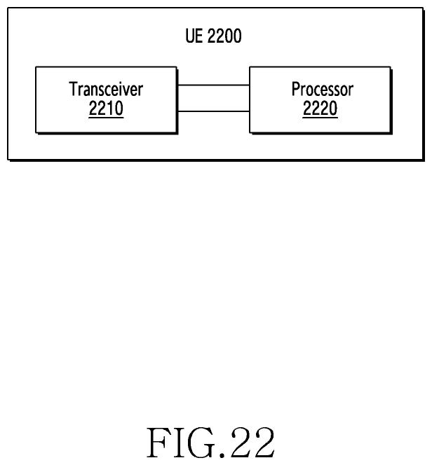

FIG. 22 illustrates a UE 2200 in a wireless communication system according to an embodiment.

Referring to FIG. 22, the UE 2200 may include a transceiver 2210 and a processor 2220. The transceiver 2210 may be configured to transmit and receive signals. The processor 2220 may be coupled to the transceiver 2220 and may be configured to (e.g., control transceiver 2210 to) perform any method performed by a UE in a wireless communication system according to an embodiment.

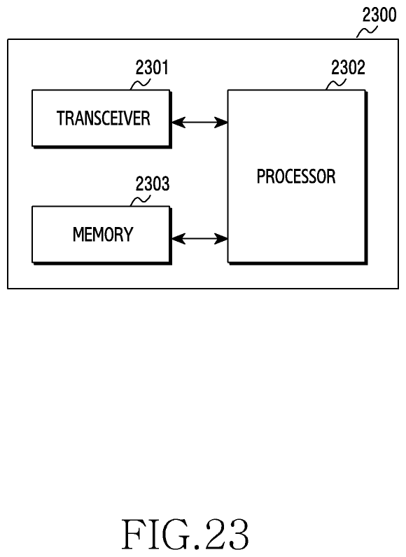

FIG. 23 is a terminal or UE 2300 according to an embodiment of the disclosure.

The terminal is an electronic device capable of wireless communication, may include a UE, a portable phone, a smartphone, a tablet, an IoT device, etc., having various form factors, and may perform wireless communication with a BS through a wireless channel.

Referring to FIG. 23, the UE 2300 may include at least one transceiver 2301, at least one processor 2302, and at least one memory 2303. According to at least one or a combination of methods corresponding to the embodiments described in the present disclosure, the transceiver 2301, the processor 2302, and the memory 2303 of the UE 2300 may operate. However, components of the UE 2300 are not limited to the illustration in FIG. 23 and the UE 2300 may further include additional components in addition to the above-mentioned components, or some components may be omitted.

The transceiver 2301 may be a communication circuit or communication circuitry that enables the UE 2300 to perform wireless communication with a node or an entity of a network. For example, the transceiver 2301 may enable the UE 2300 to transmit or receive a signal to or from a BS through cellular communication, or to transmit or receive a signal to or from another UE through cellular communication. For example, the transceiver 2301 may support at least one of various cellular communication technologies including 3G, 4G, LTE, 5G NR, 6G, and various cellular wireless communication technologies supported by the transceiver (2301) may include all subsequent generations of evolved wireless communications.

The UE 2300 may include a plurality of transceivers. For example, in the case of supporting evolved-universal terrestrial radio access-new radio (E-UTRA-NR) dual connectivity (EN-DC), the UE 2300 may include a first transceiver supporting the 4G LTE wireless communication and a second transceiver supporting the 5G NR wireless communication. In the case of supporting NR-dual connectivity (NR-DC), the UE 2300 may include a plurality of transceivers supporting the 5G NR wireless communication. In the case of supporting near field wireless communication, the UE 2300 may separately include a transceiver supporting at least one standard in the group of wireless communication protocol standards as defined in the protocol standards for Bluetooth®, wireless local area network (WLAN) network (including institute of electrical and electronics engineers (IEEE) 802.11-2016 standard or its amendments, e.g., 802.11ah, 802.11ad, 802.11ay, 802.11ax, 802.11az, 802.11ba, and 802.11be, without being limited thereto).

The transceiver 2301 may include various circuit structures used to transmit or receive signals to or from a BS through a wireless channel. The signals may include control information and data. For example, the transceiver 2301 may include a radio frequency (RF) transmitter for up-converting and amplifying the frequency of a transmitted signal and an RF receiver for low-noise-amplifying a received signal and down-converting the frequency thereof. The transceiver 2301 may output a signal received through a wireless channel to the processor 2302 and may transmit, through a wireless channel, a signal output from the processor 2302.

The processor 2302 may control general operations of the UE 2300 according to embodiments of the disclosure. The processor 2302 may be implemented by one or more integrated circuit (or circuitry) (IC) chips and may execute various data processing. The processor 2302 may include at least one electric circuit, and may execute instructions (or a program, codes, data, etc.) stored in the memory 2303, individually, collectively or in any combination thereof. The processor 2302 may include a single-core processor or multi-core processor, and may include a processor assembly including a plurality of processing circuits (circuitry) according to a specific implementation scheme.

The processor 2302 may be electrically, operatively, or communicatively coupled to the transceiver 2301 to control the transceiver 2301.

The processor 2302 may include at least one processor (or processing circuitry), and the at least one processor may perform the following operations individually, collectively or in any combination thereof. For example, the processor 2302 may include a communication processor (CP) configured to control communication operations and an application processor (AP) configured to control execution of an upper layer (for example, an application layer). In a specific embodiment, at least a part of the processor 2302 may be included in one chip and the other part of the processor 2302 may be included in another chip. Otherwise, at least one processor may be included in another component the transceiver 2301 or the memory 2303.

The processor 2302 may perform or control or cause an operation of the UE 2300 for executing at least one or a combination of methods according to embodiments of the disclosure. For example, the processor 2302 may control operations of the UE 2300 for processing a downlink signal received from a BS or generating and transmitting an uplink signal to a BS. To this end, the processor 2302 may execute a computer program, codes, or instructions stored in the memory 2303, so as to control other components of the UE 2300 to enable execution of various operations.

The memory 2303 corresponds to a hardware storage device capable of temporarily or permanently storing information and may include one or more storage media. For example, the memory 2303 may include a memory assembly including one or more storage media. For example, the one or more storage media may include permanent memory, such as a hard drive, flash memory, or read-only memory (ROM), semipermanent memory, such as random access memory (RAM), cache memory, or a combination thereof.

The memory 2303 may be electrically, operatively, or communicatively coupled to the processor 2302 and may be accessed by the processor 2302.

The memory 2303 may store a computer program, codes, or instructions executable by the processor 2302. According to an embodiment, a computer program, codes, or instructions executable by the processor 2302 may be either stored in a single memory device or separated and distributedly stored in two or more memory devices. By executing the instructions stored in the memory 2303, the processor 2302 may perform various functions according to an embodiment of the disclosure.

According to an embodiment of the disclosure, operations of the UE 2300 may be caused to be performed based on execution of instructions (or a computer program or codes) stored in the memory 2303 by at least one processor (or processing circuitry) configured to execute the same individually, collectively, or in any combination thereof, based on processing circuitry that is not configured to execute instructions, and/or based on components of processing circuitry that is not configured to execute instructions.

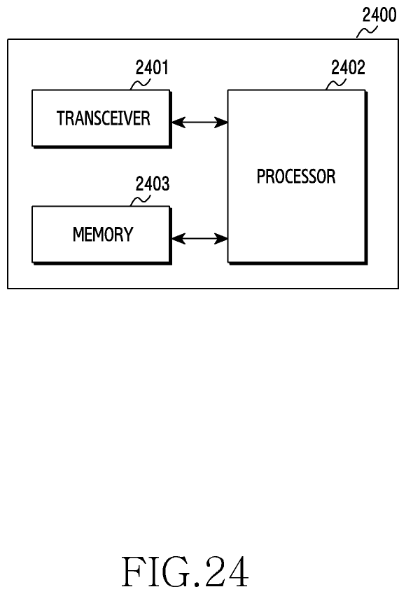

FIG. 24 is a BS 2400 according to an embodiment.

The BS 2400 may perform wireless communication with at least one UE located within the area of the BS 2400 through a wireless channel.

Referring to FIG. 24, the BS 2400 may include at least one transceiver (hereinafter, transceiver) 2401, at least one processor (hereinafter, processor) 2402, and at least one memory (hereinafter, memory) 2403. According to at least one or a combination of methods corresponding to the embodiments described in the present disclosure, the transceiver 2401, the processor 2402, and the memory 2403 of the BS 2400 may operate. However, components of the BS 2400 are not limited to the exemplary components illustrated in FIG. 24. The BS 2400 may further include additional components in addition to the above-mentioned components, or some components may be omitted. Any combination of the transceiver 2401, the processor 2402, or the memory 2403 may be integrated in the form of one component.

The transceiver 2401 may be a communication circuit or communication circuitry that enables the BS 2400 to perform wireless communication with a node or an entity of a network. For example, the transceiver 2401 may enable the BS 2400 to transmit or receive a signal to or from the UE X00 through cellular communication, or to transmit or receive a signal to or from another network entity through wireless communication. For example, the transceiver 2401 may support various cellular communication technologies including 3G, 4G, LTE, 5G NR, 6G, and various cellular wireless communication technologies supported by the transceiver (2401) may include all subsequent generations of evolved wireless communications. The transceiver 2401 may include various circuit structures used to transmit or receive signals to or from a UE through a wireless channel. The signals may include control information and data. For example, the transceiver 2401 may include a radio frequency (RF) transmitter for up-converting and amplifying the frequency of a transmitted signal and an RF receiver for low-noise-amplifying a received signal and down-converting the frequency thereof. The transceiver 2401 may output a signal received through a wireless channel to the processor 2402 and may transmit, through a wireless channel, a signal output from the processor 2402.

The BS 2400 may perform communication with a node or an entity of a network through wired or wireless communication. For example, the BS 2400 may perform wired or wireless communication with an adjacent BS, or a node or an entity of a core network through a backhaul network. When the BS 2400 performs wired communication, the BS 2400 may further include a separate network interface for wired communication in addition to the transceiver 2401. The network interface may be referred to as network interface circuitry or communication interface circuitry.

The processor 2402 may control general operations of the BS 2400 according to embodiments of the disclosure. The processor 2402 may be implemented by one or more IC chips and may execute various data processing. The processor 2402 may include at least one electric circuit, and may execute instructions (or a program, codes, data, etc.) stored in the memory 2403, individually, collectively or in any combination thereof. Further, the processor 2402 may include a single-core processor or multi-core processor, and may include a processor assembly including a plurality of processing circuits (circuitry) according to a specific implementation scheme.

The processor 2402 may be electrically, operatively, or communicatively coupled to the transceiver 2401 to control the transceiver 2401.

The processor 2402 may include at least one processor (or processing circuitry), and the at least one processor may perform the following operations individually, collectively or in any combination thereof. In a specific embodiment, at least a part of the processor 2402 may be included in one chip and the other part of the processor 2402 may be included in another chip. Otherwise, at least one processor may be included in another component the transceiver 2401 or the memory 2403.

The processor 2402 may perform or control or cause an operation of the BS 2400 for executing at least one or a combination of methods according to embodiments of the disclosure. For example, the processor 2402 may control operations of the BS 2400 for generating and transmitting a downlink signal to a UE or processing an uplink signal received from a UE. Otherwise, the BS 2400 may transmit or receive a signal to or from a neighboring BS, transfer a signal received from a UE to an upper node of the network, or transmit a signal transferred from an upper node of the network to a UE. To this end, the processor 2402 may execute a computer program, codes, or instructions stored in the memory 2403, so as to control other components of the BS 2400 to enable execution of various operations.

The memory 2403 corresponds to a hardware storage device capable of temporarily or permanently storing information and may include one or more storage media. For example, the memory 2403 may include a memory assembly including one or more storage media. For example, the one or more storage media may include permanent memory, such as a hard drive, flash memory, or read-only memory (ROM), semipermanent memory, such as random access memory (RAM), cache memory, or a combination thereof.

The memory 2403 may be electrically, operatively, or communicatively coupled to the processor 2402 and may be accessed by the processor 2402.

The memory 2403 may store a computer program, codes, or instructions executable by the processor 2402. A computer program, codes, or instructions executable by the processor 2402 may be either stored in a single memory device or separated and distributedly stored in two or more memory devices. By executing the instructions stored in the memory 2403, the processor 2402 may perform various functions according to an embodiment of the disclosure.

According to an embodiment of the disclosure, operations of the BS 2400 may be caused to be performed based on execution of instructions (or a computer program or codes) stored in the memory 2403 by at least one processor (or processing circuitry) configured to execute the same individually, collectively, or in any combination thereof, based on processing circuitry that is not configured to execute instructions, and/or based on components of processing circuitry that is not configured to execute instructions.

The UE or the BS may perform various communication procedures related to the control plane or the user plane by cooperating with one or more network entities based on wireless communication. For example, the UE may communicate with network entity such as an Access and Mobility Management Function (AMF) or a Session Management Function (SMF) via the BS, or the BS may perform at least one communication procedure by directly transmitting and receiving signals to/from, or relaying signals between, the network entities.

The structure of the above-described network entity will be described in more detail with reference to the drawings.

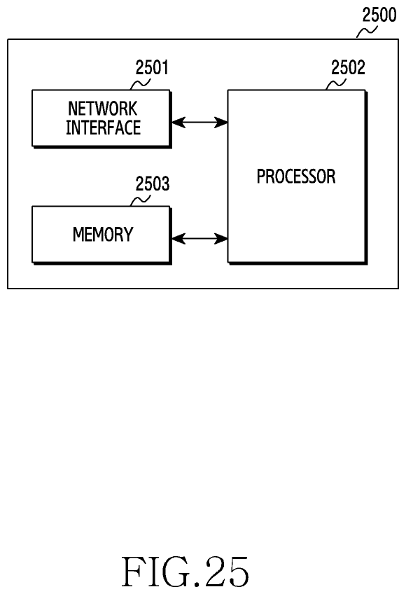

FIG. 25 is a network entity 2500 according to an embodiment of the disclosure.

Referring to FIG. 25, the network entity 2500 may include an entity (apparatus, device, or server, etc.) that performs one or more network functions (NFs) or a part of a network function constituting a core network (e.g., a 5th generation (5G) core (5GC)) in a communication system. In this case, multiple NFs may be implemented within a single network entity, or a single NF may be distributed and implemented across a plurality of network entities. In addition, when an NF is implemented within the network entity, the NF may be implemented in the form of software, and in such a case, a program for operating the NF may be stored in memory of the network entity 2500.

A single NF may be implemented by one or more instances, which may be deployed on the same network entity or distributed across multiple network entities to operate. The instance may be a software unit that logically executes a specific network function, and may be implemented in a form that is decoupled from physical hardware resources. Further, one or more NFs may be implemented in the form of one network slice to operate to satisfy specifications required by a particular service.

The NF may include at least one of an AMF, SMF, a local SMF (L-SMF), a UPF, an L-UPF, a PCF, a UDM, a UDR, an NEF, an NRF, an AF, a network slice selection function (NSSF), a network data analytics function (NWDAF), a network slice admission control function (NSACF), an authentication server function (AUSF), or a data network (DN).

Referring to FIG. 25, the network entity 2500 may include at least one network interface 2501, at least one processor 2502 (hereinafter, “processor”), and at least one memory 2503 (hereinafter, “memory”). As described above, a NF may be implemented in the form of a physical device such as the network entity 2500, or may be virtualized and executed in the form of an instance. When implemented as an instance, the NF need not necessarily include physical components as illustrated in FIG. 25. In such a case, the instance may be logically represented as comprising one or more logical functional elements.

According to at least one or a combination of methods corresponding to the embodiments described in the present disclosure, the network interface 2501, the processor 2502, and the memory 2503 of the network entity 2500 may operate. However, components of the network entity 2500 are not limited to the exemplary components illustrated in FIG. 25. In another embodiment, the network entity 2500 may further include additional components in addition to the above-mentioned components, or some components may be omitted. The network interface 2501, the processor 2502, or the memory 2503 may be integrated in the form of one component.

The network interface 2501 is a collective term for a transmitter part of the network entity 2500 and a receiver part of the network entity 2500, and may be a communication circuit for transmitting or receiving a signal to or from a UE, a BS, or another network entity. Here, the communication circuit may include both a communication circuit for wireless communication and a communication circuit for a wired communication. For example, the network interface 2501 may include a circuit, logic, hardware, etc., configured to exchange a control plane message or a user plane message with a UE, a BS, or other core network entities through wireless communication or wired communication. The network interface 2501 may operate using various protocols (e.g., NAS protocol). The network interface 2501 may also be referred to, for convenience of description or depending on implementation, as communication circuitry, network interface circuitry, or a communication interface circuitry.

The processor 2502 may control general operations of the network entity 2500 according to embodiments of the disclosure. The processor 2502 may be implemented by one or more IC chips and may execute various data processing. The processor 2502 may include at least one electric circuit, and may execute instructions (or a program, codes, data, etc.) stored in the memory 2503, individually, collectively or in any combination thereof. Further, the processor 2502 may include a single-core processor or multi-core processor, and may include a processor assembly including a plurality of processing circuits (circuitry) according to a specific implementation scheme. Further, it should be noted that, according to another embodiment, in when NF is implemented in the form of an instance, the network function may be not necessarily configured by physical hardware.

According to an embodiment, the processor 2502 may be electrically, operatively, or communicatively coupled to the network interface 2501 to control the network interface 2501.

The processor 2502 may include at least one processor (or processing circuitry), and the at least one processor may perform the following operations individually, collectively or in any combination thereof. In a specific embodiment, at least a part of the processor 2502 may be included in one chip and the other part of the processor 2502 may be included in another chip. Otherwise, at least one processor may be included in another component the network interface 2501 or the memory 2503.

The processor 2502 may perform or control or cause an operation of the network entity 2500 for executing at least one or a combination of methods according to embodiments of the disclosure. For example, the processor 2502 may control operations of the network entity 2500 for exchanging a control plane message or a user plane message with a UE, a BS, or other core network entities through wireless or wired communication, using various protocols (e.g., NAS protocol). To this end, the processor 2502 may execute a computer program, codes, or instructions stored in the memory 2503, so as to control other components of the network entity 2500 to enable execution of various operations.

The memory 2503 corresponds to a hardware storage device capable of temporarily or permanently storing information and may include one or more storage media. For example, the memory 2503 may include a memory assembly including one or more storage media. For example, the one or more storage media may include permanent memory, such as a hard drive, flash memory, or read-only memory (ROM), semipermanent memory, such as random access memory (RAM), cache memory, or a combination thereof.

The memory 2503 may be electrically, operatively, or communicatively coupled to the processor 2502 and may be accessed by the processor 2502.

The memory 2503 may store a computer program, codes, or instructions executable by the processor 2502. According to an embodiment, a computer program, codes, or instructions executable by the processor 2502 may be either stored in a single memory device or separated and distributedly stored in two or more memory devices. By executing the instructions stored in the memory 2503, the processor 2502 may perform various functions according to an embodiment of the disclosure.

Operations of the network entity 2500 may be caused to be performed based on execution of instructions (or a computer program or codes) stored in the memory 2503 by at least one processor (or processing circuitry) configured to execute the same individually, collectively, or in any combination thereof, based on processing circuitry that is not configured to execute instructions, and/or based on components of processing circuitry that is not configured to execute instructions.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as a storage device like read only memory (ROM), whether erasable or rewritable or not, or in the form of memory such as random access memory (RAM), memory chips, device or ICs or on an optically or magnetically readable medium such as a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments of the present disclosure may provide a program comprising code for implementing apparatus or a method as claimed in any one of the claims of this specification and a non-transitory machine-readable storage storing such a program.

Any of the functions or operations described herein can be processed by one processor or a combination of processors. The one processor or the combination of processors is circuitry performing processing and includes circuitry like an application processor (AP, e.g. a CPU), a communication processor (CP, e.g., a modem), a graphics processing unit (GPU), a neural processing unit (NPU) (e.g., an AI chip), a Wi-Fi chip, a Bluetooth® chip, a global positioning system (GPS) chip, a near field communication (NFC) chip, connectivity chips, a sensor controller, a touch controller, a finger-print sensor controller, a display driver IC, an audio CODEC chip, a universal serial bus (USB) controller, a camera controller, an image processing IC, a microprocessor unit (MPU), a system on chip (SoC), an IC, or the like.

Herein, each block of the flowchart illustrations, and combinations of blocks in the flowchart illustrations, may be performed based on computer program instructions. These computer program instructions may be loaded collectively onto at least one processor of a general purpose computer, special purpose computer, or other programmable data processing apparatus to produce a machine, such that the instructions, which perform through any one of, or in any combination of, the at least one processor of the computer or other programmable data processing apparatus, create means for performing the functions specified in the flowchart block(s). These computer program instructions may also be stored in a non-transitory computer usable or computer-readable memory that may direct a computer or other programmable data processing apparatus to function in a particular manner, such that the instructions stored in the computer usable or computer-readable memory produce an article of manufacture including instruction indicates that perform the function specified in the flowchart block(s). The computer program instructions may also be loaded onto a computer or other programmable data processing apparatus to cause a series of operational steps to be performed on the computer or other programmable data processing apparatus to produce a computer executed process such that the instructions that perform on the computer or other programmable data processing apparatus provide steps for executing the functions specified in the flowchart block(s).

Each block may represent a module, segment, or portion of code, which includes one or more executable instructions for executing the specified logical function(s). It should also be noted that in some alternative implementations, the functions noted in the blocks may occur out of order. For example, two blocks (or functions) shown in succession may in fact be performed substantially concurrently or the blocks may sometimes be performed in the reverse order, depending upon the functionality involved.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

While the disclosure has been described with reference to various embodiments, various changes may be made without departing from the spirit and the scope of the present disclosure, which is defined, not by the detailed description and embodiments, but by the appended claims and their equivalents.

What is claimed is:

1. A method performed by a first node in a wireless communication system, the method comprising:
receiving first information and fourth information from a wireless access backhaul-mobile terminal (WAB-MT), wherein the first information comprises at least one of information indicating that the WAB-MT is a WAB node or a WAB-MT, an identification of a co-located WAB-gNB of the WAB-MT, a request for an Internet protocol (IP) address of the first node, and the fourth information comprises a request for an IP address of a neighbor node of the first node; and
transmitting second information and fifth information to the WAB-MT, wherein the second information comprises the IP address of the first node, and the fifth information comprises the IP address of the neighbor node of the first node,
wherein the IP address is used for the co-located WAB-gNB of the WAB-MT to transmit an Xn setup request to the first node, and
wherein the IP address of the neighbor node is used for the co-located WAB-gNB of the WAB-MT to transmit an Xn setup request to the neighbor node.

2. The method of claim 1, further comprising:
receiving third information from the WAB-MT, wherein the third information comprises an IP address of the co-located WAB-gNB of the WAB-MT; and
transmitting an Xn setup request to the co-located WAB-gNB of the WAB-MT based on the IP address of the co-located WAB-gNB of the WAB-MT.

3. The method of claim 1, further comprising:
receiving sixth information from the WAB-MT, wherein the sixth information comprises at least one of information indicating that the WAB-MT is a WAB node or a WAB-MT, an identification and/or an IP address of a co-located WAB-gNB of the WAB-MT, a request for an IP address of a neighbor node of the first node;
transmitting fifth information to the co-located WAB-gNB of the WAB-MT, wherein the fifth information comprises the IP address of the neighbor node of the first node; and
receiving seventh information from a co-located WAB-gNB of the WAB-MT, wherein the seventh information comprises information indicating that a neighbor node list of the co-located WAB-gNB is identical to a neighbor node list of the first node.

4. The method of claim 1, further comprising:
receiving fourth information from a co-located WAB-gNB of the WAB-MT, wherein the fourth information comprises a request for an IP address of a neighbor node of the first node;
transmitting fifth information to the co-located WAB-gNB, wherein the fifth information comprises the IP address of the neighbor node of the first node,
wherein the IP address of the neighbor node of the first node is used for the co-located WAB-gNB to transmit an Xn setup request to the neighbor node of the first node.

5. The method of claim 1, further comprising:
transmitting an eleventh information to a second node, wherein the eleventh information comprises a first neighbor node list of the first node, wherein the first neighbor node list comprises information on whether each neighbor node in the first neighbor node list is a WAB node; and
receiving a twelfth information from the second node, wherein the twelfth information comprises a second neighbor node list of the second node, wherein the second neighbor node list comprises information on whether each neighbor node in the second neighbor node list is a WAB node.

6. The method of claim 1, further comprising:
receiving a seventh message from the WAB-MT, wherein the seventh message comprises a handover request transmitted by the co-located WAB-gNB to the first node; and
transmitting an eighth message to the WAB-MT, wherein the eighth message comprises a handover request acknowledge message or a handover preparation failure message transmitted by the first node to the co-located WAB-gNB.

7. The method of claim 1, further comprising:
receiving a ninth message from the WAB-MT, wherein the ninth message comprises at least one of an identification and/or an IP address of a co-located WAB-gNB of the WAB-MT, an identification and/or an IP address of a target node, an identification of a UE for which cell handover is to be performed, a handover request of the co-located WAB-gNB;
transmitting a tenth message to the WAB-MT, wherein the tenth message comprises information on whether the first node agrees to transmit the handover request of the co-located WAB-gNB to the target node;
transmitting an eleventh message to the target node, wherein the eleventh message comprises a handover request of the co-located WAB-gNB, and eighth information on transmitting a handover request acknowledge or handover preparation failure for the handover request to the first node;
receiving a twelfth message from the target node, wherein the twelfth message comprises a handover request acknowledge or handover preparation failure for the handover request, and ninth information on transmitting the handover request acknowledge or handover preparation failure to the co-located WAB-gNB; and
transmitting a thirteenth message to the WAB-MT, wherein the thirteenth message comprises the handover request acknowledge or handover preparation failure, and tenth information on transmitting the handover request acknowledge or handover preparation failure to the co-located WAB-gNB.

8. A method performed by a wireless access backhaul-mobile terminal (WAB-MT) in a wireless communication system, the method comprising:
transmitting first information and fourth information to a first node, wherein the first information comprises at least one of information indicating that the WAB-MT is a WAB node or a WAB-MT, an identification of a co-located WAB-gNB of the WAB-MT, a request for an Internet Protocol (IP) address of the first node, and the fourth information comprises a request for an IP address of a neighbor node of the first node; and
receiving second information and fifth information from the first node, wherein the second information comprises the IP address of the first node, and the fifth information comprises the IP address of the neighbor node of the first node,
wherein the IP address is used for the co-located WAB-gNB of the WAB-MT to transmit an Xn setup request to the first node, and
wherein the IP address of the neighbor node is used for the co-located WAB-gNB of the WAB-MT to transmit an Xn setup request to the neighbor node.

9. The method of claim 8, further comprising:
transmitting the IP address of the neighbor node of the first node to the co-located WAB-gNB of the WAB-MT.

10. The method of claim 8, further comprising:
transmitting third information to the first node, wherein the third information comprises an IP address of the co-located WAB-gNB of the WAB-MT,
wherein the IP address of the co-located WAB-gNB of the WAB-MT is used by the first node to transmit an Xn setup request to the co-located WAB-gNB of the WAB-MT.

11. The method of claim 8, further comprising transmitting sixth information to the first node, wherein the sixth information comprises at least one of information indicating that the WAB-MT is a WAB node or a WAB-MT, an identification and/or an IP address of a co-located WAB-gNB of the WAB-MT, a request for an IP address of a neighbor node of the first node,
wherein fifth information is transmitted by the first node to the co-located WAB-gNB of the WAB-MT, wherein the fifth information comprises the IP address of the neighbor node of the first node, and
wherein seventh information is transmitted by the co-located WAB-gNB of the WAB-MT to the first node, wherein the seventh information comprises information indicating that a neighbor node list of the co-located WAB-gNB is identical to a neighbor node list of the first node.

12. The method of claim 8, further comprising:
transmitting a seventh message to the first node, wherein the seventh message comprises a handover request transmitted by the co-located WAB-gNB to the first node; and
receiving an eighth message from the first node, wherein the eighth message comprises a handover request acknowledge message or a handover preparation failure message transmitted by the first node to the co-located WAB-gNB.

13. The method of claim 8, further comprising:
transmitting a ninth message to the first node, wherein the ninth message comprises at least one of an identification and/or an IP address of a co-located WAB-gNB of the WAB-MT, an identification and/or an IP address of a target node, an identification of a UE for which cell handover is to be performed, a handover request of the co-located WAB-gNB;
receiving a tenth message from the first node, wherein the tenth message comprises information on whether the first node agrees to transmit the handover request of the co-located WAB-gNB to the target node; and
receiving a thirteenth message from the first node, wherein the thirteenth message comprises a handover request acknowledge or handover preparation failure for the handover request transmitted by the target node, and tenth information on transmitting the handover request acknowledge or handover preparation failure to the co-located WAB-gNB.

14. A method performed by a UE in a wireless communication system, the method comprising:
receiving a radio resource control (RRC) reconfiguration message from a WAB-gNB; and
transmitting an RRC reconfiguration complete message to a first node,
wherein first and fourth information are transmitted from a co-located wireless access backhaul-mobile terminal (WAB-MT) of the WAB-gNB to the first node, wherein the first information comprises at least one of information indicating that the WAB-MT is a WAB node or a WAB-MT, an identification of the WAB-gNB, a request for an Internet Protocol (IP) address of the first node, and the fourth information comprises a request for an IP address of a neighbor node of the first node,
wherein second information and fifth information are transmitted from the first node to the WAB-MT, wherein the second information comprises the IP address of the first node and the fifth information comprises the IP address of the neighbor node of the first node,
wherein the IP address is used for the WAB-gNB to transmit an Xn setup request to the first node, and
wherein the IP address of the neighbor node is used for the co-located WAB-gNB to transmit an Xn setup request to the neighbor node.

15. A node device in a wireless communication system, the node device comprising:
at least one transceiver;
at least one processor communicatively coupled to the at least one transceiver; and
at least one memory, communicatively coupled to the processor, configured for storing instructions executable by the processor individually or in any combination to cause the node device to:
receive first information and fourth information from a wireless access backhaul-mobile terminal (WAB-MT), wherein the first information comprises at least one of information indicating that the WAB-MT is a WAB node or a WAB-MT, an identification of a co-located WAB-gNB of the WAB-MT, a request for an Internet Protocol (IP) address of the node device, and the fourth information comprises a request for an IP address of a neighbor node of the node device, and
transmit second information and fifth information to the WAB-MT, wherein the second information comprises the IP address of the node device, and the fifth information comprises the IP address of the neighbor node of the node device,
wherein the IP address is used for the co-located WAB-gNB of the WAB-MT to transmit an Xn setup request to the node device, and
wherein the IP address of the neighbor node is used for the co-located WAB-gNB of the WAB-MT to transmit an Xn setup request to the neighbor node.

16. The node device of claim 15, wherein the instructions further cause the node device to:
receive third information from the WAB-MT, wherein the third information comprises an IP address of the co-located WAB-gNB of the WAB-MT; and
transmit an Xn setup request to the co-located WAB-gNB of the WAB-MT based on the IP address of the co-located WAB-gNB of the WAB-MT.

17. The node device of claim 15, wherein the instructions further cause the node device to:
receive sixth information from the WAB-MT, wherein the sixth information comprises at least one of information indicating that the WAB-MT is a WAB node or a WAB-MT, an identification and/or an IP address of a co-located WAB-gNB of the WAB-MT, a request for an IP address of a neighbor node of the node device,
transmit fifth information to the co-located WAB-gNB of the WAB-MT, wherein the fifth information comprises the IP address of the neighbor node of the node device, and
receive seventh information from a co-located WAB-gNB of the WAB-MT, wherein the seventh information comprises information indicating that a neighbor node list of the co-located WAB-gNB is identical to a neighbor node list of the node device.

18. The node device of claim 15, wherein the instructions further cause the node device to:
receive fourth information from a co-located WAB-gNB of the WAB-MT, wherein the fourth information comprises a request for an IP address of a neighbor node of the node device;
transmit fifth information to the co-located WAB-gNB, wherein the fifth information comprises the IP address of the neighbor node of the node device,
wherein the IP address of the neighbor node of the node device is used for the co-located WAB-gNB to transmit an Xn setup request to the neighbor node of the node device.

19. A wireless access backhaul-mobile terminal (WAB-MT) in a wireless communication system, comprising:
at least one transceiver;
at least one processor communicatively coupled to the at least one transceiver; and
at least one memory, communicatively coupled to the at least one processor, storing instructions executable by the at least one processor individually or in any combination to cause the WAB-MT to:
transmit first information and fourth information to a first node, wherein the first information comprises at least one of: information indicating that the WAB-MT is a WAB node or a WAB-MT, an identification of a co-located WAB-gNB of the WAB-MT, a request for an Internet Protocol (IP) address of the first node, and the fourth information comprises a request for an IP address of a neighbor node of the first node, and
receive second information and fifth information from the first node, wherein the second information comprises the IP address of the first node, and the fifth information comprises the IP address of the neighbor node of the first node,
wherein the IP address is used for the co-located WAB-gNB of the WAB-MT to transmit an Xn setup request to the first node, and
wherein the IP address of the neighbor node is used for the co-located WAB-gNB of the WAB-MT to transmit an Xn setup request to the neighbor node.

20. A UE in a wireless communication system, comprising:
at least one transceiver;
at least one processor communicatively coupled to the at least one transceiver; and
at least one memory, communicatively coupled to the at least one processor, storing instructions executable by the at least one processor individually or in any combination to cause the UE to:
receive a radio resource control (RRC) reconfiguration message from a WAB-gNB, and
transmit an RRC reconfiguration complete message to a first node,
wherein first and fourth information are transmitted from a co-located wireless access backhaul-mobile terminal (WAB-MT) of the WAB-gNB to the first node, wherein the first information comprises at least one of: information indicating that the WAB-MT is a WAB node or a WAB-MT, an identification of the WAB-gNB, a request for an Internet Protocol (IP) address of the first node, and the fourth information comprises a request for an IP address of a neighbor node of the first node,
wherein second information and fifth information are transmitted from the first node to the WAB-MT, wherein the second information comprises the IP address of the first node and the fifth information comprises the IP address of the neighbor node of the first node,
wherein the IP address is used for the WAB-gNB to transmit an Xn setup request to the first node, and
wherein the IP address of the neighbor node is used for the co-located WAB-gNB to transmit an Xn setup request to the neighbor node.
